(19) United States
(12) Patent Application Publication
(10) Pub. No.: US 2002/0071936 A1
(43) Pub. Date: Jun. 13, 2002

(54) Advanced floor mat

(76) Inventors: Andrew Gentiluomo, Roanoke, VA (US); Peter W. Kopf, Sudbury, MA (US); Arthur Wildstein, Marietta, GA (US)

Correspondence Address: KENYON & KENYON, 1500 K STREET, N.W., SUITE 700, WASHINGTON, DC, 20005, US

(21) Appl. No.: 09/981,827

(22) Filed: Oct. 19, 2001

Related U.S. Application Data
(63) Continuation-in-part of application No. 09/935,672, filed on Aug. 24, 2001.
Application No. 09/935,672 is a continuation-in-part of application No. PCT/US00/30206, filed on Nov. 2, 2000.
Application No. PCT/US00/30206 is a continuation-in-part of application No. 09/553,234, filed on Apr. 19, 2000.
Application No. 09/553,234 is a continuation-in-part of application No. 09/418,752, filed on Oct. 15, 1999, now abandoned.
Application No. 09/418,752 is a continuation-in-part of application No. 09/304,051, filed on May 4, 1999.

(51) Int. Cl. A47L 23/22; B32B 9/00

(52) U.S. Cl. 428/167; 15/104.002; 15/215; 428/41.5; 428/156

(57) ABSTRACT

An advanced floor mat is disclosed. In an embodiment of the present invention, the floor mat includes a cleanable portion. The floor mat may also include a water dissipation component, a water absorbing component, a cushioning component, customized graphics, a transparent cleanable portion, a tacky surface on the cleanable portion, an antibacterial composition, an antifungal composition, and a fragrance. The cleanable portion may be erodible and may include a plurality of cleanable reusable layers. If a tacky surface is included in the floor mat, an anti-slip feature may be associated with the tacky surface to help prevent slipping on a possibly wet tacky surface. Additionally, a sensor system may be included in the floor mat to assist a user in identifying when the floor mat may require cleaning.

This application is a continuation-in-part of U.S. application Ser. No. 09/935,672, filed Aug. 24, 2001, which is a continuation-in-part of international application no. PCT/US00/30206, filed Nov. 2, 2000, which is a continuation-in-part of U.S. application Ser. No. 09/553,234, filed Apr. 19, 2000 and issued May 22, 2001 as U.S. Pat. No. 6,233,776. Application Ser. No. 09/553,234 is a continuation-in-part of U.S. application Ser. No. 09/418,752, filed Oct. 15, 1999, which is a continuation-in-part of U.S. application Ser. No. 09/304,051, filed May 4, 1999 and issued Apr. 24, 2001 as U.S. Pat. No. 6,219,876.

### BACKGROUND AND DISCUSSION OF THE INVENTION

The present invention relates to a floor mat. More specifically, the invention provides a floor mat that includes a cleanable portion. The floor mat may also include a water dissipation component, a water absorbing component, a cushioning component, customized graphics, a transparent cleanable portion, a tacky surface on the cleanable portion, an antibacterial composition, an antifungal composition, and a fragrance. The cleanable portion may be erodible and may include a plurality of cleanable reusable layers. If a tacky surface is included in the floor mat, an anti-slip feature may be associated with the tacky surface to help prevent slipping on a possibly wet tacky surface. Additionally, a sensor system may be included in the floor mat to assist a user in identifying when the floor mat may require cleaning.

Floor mats are known for cleaning the soles of a person's shoes who is about to enter a particular area or room. One problem with floor mats in general is how to keep the floor mat sufficiently clean such that it may perform its function of cleaning the person's shoes when, by its very nature, it is purposefully dirtied when performing its function.

Known floor mats may be comprised of a single, unitary piece of material. Whereas these single structure floor mats may be kept clean by, for example, washing the floor mat, it may be required that the entire floor mat be removed from its location for washing and thus, the floor mat is not available where desired while the entire mat is being cleaned. Alternatively, even if the mat can be cleaned in-place, which may not be a possibility if it is located in, for example, a carpeted area, it may be inconvenient to clean the mat in-place.

U.S. Pat. No. 3,785,102 to Amos discloses a throw-away pad comprising a plurality of stacked disposable sheets where, when a particular sheet is dirtied, the dirty sheet is removed and disposed of. The next sheet that is exposed after the dirty sheet is discarded is clean and thus, a clean surface is again available. However, there may be problems with comprising the floor mat of disposable sheets. Disposing of each dirty sheet may be uneconomical since each sheet is discarded after it becomes dirty. Additionally, after some finite number of sheets are disposed of, no sheets will remain and thus no effective cleaning surface is available.

U.S. Pat. No. 3,785,102 to Amos also discloses that an adhesive can be provided on each sheet's top surface to improve its ability to remove dirt from a person's shoes. However, again, these sheets are not cleanable and therefore are not reusable.

U.S. Pat. No. 3,717,897 to Amos et al. discloses a pad for cleaning shoes and wheels. The pad includes a thin water-washable adhesive covering its upper surface for removing dirt from shoes and wheels. Whereas the '897 patent discloses a pad with a water-washable adhesive upper surface, the pad is not known for use in domestic or office-type applications. As stated in the '897 patent, the pad is placed at an entrance doorway leading into a clean room.

Tacky floor mats are by far more popular for utilization in indoor environments that are far removed from exterior outside entrances, such as for clean rooms that are well-within the interior of the building in which they are used, e.g., hospital rooms, computer chip manufacturing spaces, and gymnasiums. Thus, tacky floor mats are not known for use in areas that are adjacent to entrances that lead from the outdoor environment for cleaning the soles of a person's shoes prior to entry into the interior of a building, such as for example in an entry foyer or on an outdoor porch.

Tacky floor mats are not known for use in domestic or office-type applications, e.g., home or business office use, because of several known deficiencies. One of these deficiencies is that their tacky surface will not be as effective if it becomes wet. Therefore, if the tacky surface floor mat was utilized in an outdoor environment, such as the outdoor porch mentioned above, or in an indoor environment that is adjacent to or near an outdoor entrance, such as an entry foyer of a home or business, for cleaning a person's shoes prior to further entering the home or business, the mat is likely to become wet and therefore not effective. The mat could become wet from, for example, the moisture in the atmosphere or from moisture carried on the soles of the person's shoes who steps on the mat. Additionally, if the tacky surface becomes wet it may become slippery and thus cause a hazard for the person who steps on it.

Additional deficiencies with using known tacky floor mats for home or office-type applications as discussed above is their likelihood of becoming trip hazards and their lack of aesthetic appeal. In the '897 patent, because the pad is designed for use in clean room environments, it is adhesively adhered to the passageway floor in front of the entrance doorway. This may be satisfactory for retaining the mat in-place in clean room-type of applications, however, if it was attempted to use the '897 pad on a carpeted floor, the pad would not properly adhere to the carpet and thus a trip hazard would be present. This could result in significant liability issues. The '897 pad does not have sufficient mass for it to remain in-place without utilizing an adhesive. Regarding aesthetics, because tacky floor mats are known only for their functional characteristics, and thus for use only in “clean room”-type applications, they are not aesthetically pleasing. Therefore, for at least the above reasons, tacky floor mats are not known for use in home or office-type applications.

Additional drawbacks with known floor mats exist that are directed to issues of customization for a particular purchaser and a lack of additional cleaning properties. A floor mat may be the first object that a visitor to a particular home or business encounters. As such, the owner of the home or business may want to utilize the floor mat to graphically convey an initial greeting or message to the visitor. Whereas floor mats are known that may include a greeting on them, it is not currently known to allow for a particular purchaser to customize the displayed graphic so that the message is tailored to convey a particular message desired by the purchaser. For example, on Halloween the purchaser may want the floor mat to display a “Happy Halloween” message. In another situation, the purchaser may want to greet a particular visitor with a message such as “Hello, Joe”. Currently, it is not known to provide a floor mat where an individual can customize the floor mat to display a particular message that they want to convey and in certain circumstances even change the floor mat's message they want to convey.

An additional problem with known floor mats, as mentioned above, is that they are limited in their ability to clean the soles of a person's shoes. Whereas known floor mats may be capable of removing dirt particles from the shoe's soles, they are not able to disinfect the soles nor provide a scent to the soles to assist in masking any unpleasant odors that may be associated with the shoes.

An additional drawback with known floor mats, even if they are cleanable, is that they do not assist a user in determining when the floor mat may require cleaning. Generally, the owner or custodian of the floor mat does not continuously or regularly monitor the condition of the floor mat with respect to cleanliness. Therefore, the floor mat could require cleaning, and because the owner is not consciously monitoring the condition of the floor mat, there could be a significant period of time before the owner realizes that the floor mat requires cleaning. Therefore, it would be desirable to assist the owner/custodian of the floor mat in determining when the floor mat requires cleaning.

Therefore, it would be desirable to provide an advanced floor mat that could address deficiencies that exist with currently known floor mats. The advanced floor mat of the present invention overcomes deficiencies in the prior art and may include a base portion which incorporates a cleanable portion that is adapted to be removably received within the floor mat. The floor mat may also include features such as a water dissipation capability, a water absorbing capability, a cushioning capability, customized graphics, a transparent portion, a tacky surface on the cleanable portion, an antibacterial composition, an antifungal composition, and a fragrance. The cleanable portion may include the features of being erodible and containing a plurality of cleanable reusable layers. If a tacky surface is included in the floor mat, an anti-slip feature may be associated with the tacky surface to help prevent slipping on a possibly wet tacky surface. Additionally, a sensor system may be included in the floor mat to assist a user in identifying when the floor mat may require cleaning. Other features will be apparent from the detailed description which follows.

### BRIEF DESCRIPTION OF THE DRAWINGS

The various features of the invention will best be appreciated by simultaneous reference to the description which follows and the accompanying drawings, in which:

FIG. 1 is a perspective view of a floor mat in accordance with an embodiment of the present invention;

FIG. 2 is an exploded perspective view of the floor mat of FIG. 1;

FIG. 3 is an exploded side view of an alternative embodiment of the floor mat of the present invention;

FIG. 4 is an exploded side view of an alternative embodiment of the floor mat of the present invention;

FIG. 5 illustrates a third alternative embodiment for a tacky insert portion with an anti-slip feature for the floor mat of the present invention;

FIG. 6 illustrates a fourth alternative embodiment for a tacky insert portion with an anti-slip feature for the floor mat of the present invention;

FIG. 7 is a side view of the embodiment for the tacky insert portion with an anti-slip feature of FIG. 6;

FIG. 8 is a perspective view of a fifth embodiment for a tacky insert portion with an anti-slip feature for the floor mat of the present invention;

FIG. 9 illustrates a sixth alternative embodiment for a tacky insert portion with an anti-slip feature for the floor mat of the present invention;

FIG. 10 illustrates the tacky insert portion with an anti-slip feature of FIG. 9 in conjunction with an alternative embodiment for the base portion;

FIG. 11 illustrates a seventh alternative embodiment for a tacky insert portion with an anti-slip feature and a water dissipating capability for the floor mat of the present invention;

FIG. 12 illustrates an alternative embodiment for a tacky insert portion and base portion with a water dissipating capability for the floor mat of the present invention;

FIG. 13 illustrates a sensor system that may be utilized in an embodiment of the present invention;

FIG. 14 is an embodiment for a floor mat where the tacky portion and the non-tacky portion are separable;

FIG. 15 is a perspective view of an embodiment of the floor mat of the present invention as being used in one step of a process for utilizing the floor mat;

FIG. 16 is a perspective view of the floor mat of FIG. 15 as being used in a second step of a process for utilizing the floor mat;

FIG. 17 illustrates an alternative embodiment for a floor mat in accordance with the present invention that includes interchangeable base portions;

FIG. 18 illustrates an alternative embodiment for a floor mat in accordance with the present invention that includes single sheets for the cleanable portion;

FIG. 19 illustrates a roll of sheets that may be utilized with the embodiment of FIG. 18;

FIG. 20 illustrates a storage container that may be utilized with the roll of sheets of FIG. 19;

FIG. 21 illustrates an alternative embodiment for a floor mat in accordance with the present invention that includes a scraper movable on tracks;

FIG. 22 illustrates an alternative embodiment for a floor mat in accordance with the present invention that includes a scraper movable on tracks;

FIG. 23 is an exploded view of a floor mat according to an embodiment of the invention;

FIG. 24A illustrates a separable section of a non-tacky layer of the floor mat, with snap fasteners for fastening the separable section to a base portion underlayer of the floor mat;

FIG. 24B illustrates a separable section of a non-tacky layer of the floor mat, with hook-and-loop fasteners for fastening the separable section to a base portion underlayer of the floor mat;

FIG. 24C shows one possible configuration for a remove tab of a tacky insert of the floor mat;

FIGS. 24D and 24E are side elevation views of a plurality of remove tabs according to two different possible arrangements;

FIG. 25 is a perspective view of a floor mat according to yet another embodiment of the invention, wherein a non-tacky layer is co-extensive with a base portion underlayer;

FIG. 26A shows two possible embodiments for an adhesive undersurface of a tacky insert;

FIGS. 26B-26D show a possible embodiment of a tacky insert and a base portion underlayer according to the invention, wherein the tacky insert has notches for aligning with protrusions on the base portion underlayer;

FIG. 27A shows details of layers in one possible embodiment of a multilayer tacky insert;

FIGS. 27B and 27C shows anti-slip material interspersed with adhesive on a layer of a tacky insert, according to one possible embodiment;

FIG. 28 illustrates three alternative process flows for manufacturing tacky inserts according to the invention;

FIGS. 29A-29C show alternative configurations of an apparatus for manufacturing tacky inserts according to the processes illustrated in FIG. 28;

FIG. 30 shows details a rotary die cutter such as could be used in the processes described in FIGS. 28 and 29A-29C;

FIGS. 31A-31D show alternative embodiments of tacky inserts, wherein the tacky inserts have apertures configured to receive nodular anti-slip components; and

FIGS. 32A-32E show possible embodiments of nodular anti-slip components.

FIGS. 33A-33C show embodiments of a floor mat according to the invention, wherein an area of a base portion underlayer of the floor mat for receiving a tacky insert includes channels therein, and has a rim with an extension for receiving a remove tab of the tacky insert.

### DETAILED DESCRIPTION

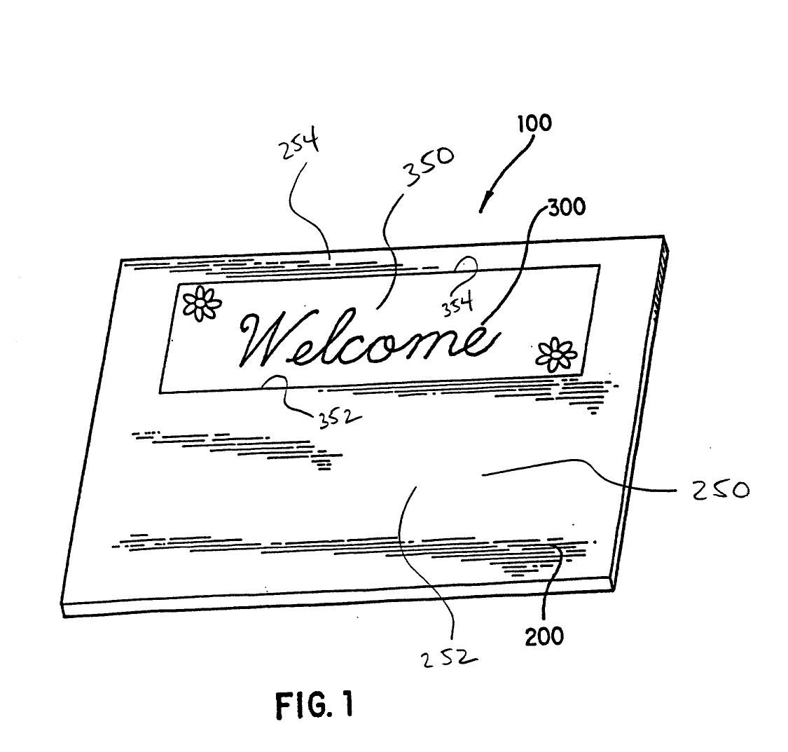

FIG. 1 illustrates a first embodiment for a floor mat 100 in accordance with the principles of the present invention. As can be seen in FIG. 1, floor mat 100 includes a base portion 200 and a cleanable insert portion 300. As will be further described later in this specification, in this embodiment, cleanable portion 300 is received within base portion 200 and is removable from base portion 200.

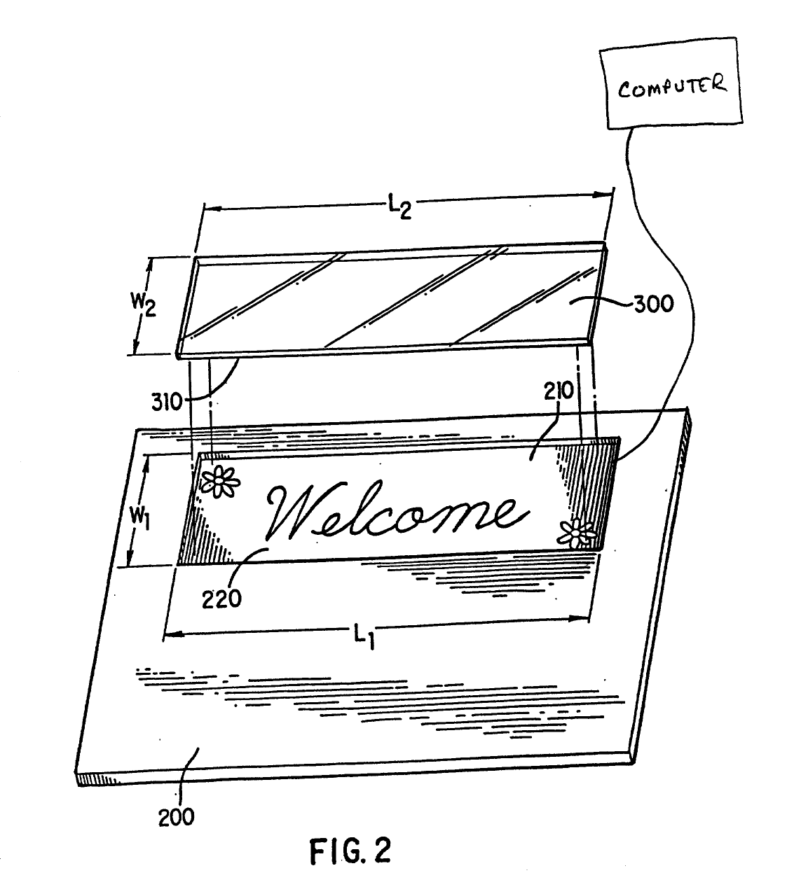

FIG. 2 illustrates an exploded, perspective view of the floor mat of FIG. 1. As can be seen in FIG. 2, base portion 200 is formed as a generally flat, planar member and defines a recess 210 within the top surface of base portion 200. Base portion 200 provides sufficient weight and mass for supporting cleanable insert portion 300 and maintaining the floor mat's positioning on the surface on which it is placed. Base portion 200 may include, as will be discussed below, a water dissipation capability, a water absorption capability, and a cushioning capability and may be comprised of materials such as polyurethane, polyisoprene and other crosslinked elastomeric materials, such as nylon-6, molded or woven to form a porous structure. Recess 210 can be configured in any of a variety of geometric configurations, however, in the present embodiment, recess 210 is configured in a rectangular shape. Recess 210 has a length L₁ and a width W₁. The depth of recess 210 is such that it is able to receive within it cleanable insert portion 300 such that when cleanable insert portion 300 is received within recess 210, the top surface of cleanable insert portion 300 lies generally in the same plane as the top surface of base portion 200.

The top surface of base portion 200 may be colored with any color depending upon the desires of a particular purchaser, however, it is preferable that a color be utilized that will minimize the visibility of any dirt that is accumulated by base portion 200. For example, it may be desirable that darker colors be utilized for the top surface of base portion 200 rather than lighter colors. However, again, any particular color may be utilized for base portion 200, and particularly the top surface of base portion 200, depending upon the particular desires of an individual. Additionally, the base portion 200 may be either translucent or opaque.

As can be seen in FIG. 2, the surface of base portion 200 which defines the bottom of recess 210 may include graphics 220 on that surface. In the illustrated embodiment, the graphics include pictorial representations of flowers and a text message which spells out the word “WELCOME”. The present invention is not limited to any particular graphic within recess 210 and the present invention may include any of a variety of different forms of graphics.

Graphics 220 may be modified, and thus customized, by an individual after the floor mat has been purchased by the owner. The owner may customize the mat at their home or office and, thus, a graphic that may be appropriate for a particular situation may be modified by the individual for display in another situation. For example, the graphic may display a message stating “Happy Halloween” for Halloween and may be modified to display “Happy Holidays” during the winter holiday season. Thus, as can be understood, the graphics are modifiable by a user and thus, may be customized for the particular desires of a particular user.

As stated above, the present invention is not limited to any particular form for graphics 220. The graphics 220 can be customized by a user to include any of a variety of different colors, pictures, messages, or other representations that the user may want to display. In addition, the visible intensity of a color(s) can be modified. For example, a color that glows at night could be included in graphics 220 for an occasion such as Halloween.

Any of a variety of different types of structures or methods may be practiced in the present invention for modifying graphics 220 of floor mat 100 and the present invention is not limited to any particular methodology or structure for modifying graphics 220. Additionally, all of the various embodiments contemplated for providing a modifiable graphic display in the floor mat of the present invention can be incorporated in either, or both, of the base portion or the insert portion. For example, the graphics may consist of pre-formed messages or art forms which may be adhered to either the surface which defines the bottom of recess 210, such as by using an adhesive or fastener assembly, e.g., a hook and loop assembly, or to the underside of insert portion 300 such that, when insert portion 300 is placed within base portion 200, the graphics would be visible through a transparent insert portion.

Alternatively, a variety of different graphics may be stored within floor mat 100 such that a user is able to selectively uncover a particular graphic for display while the other available graphics remain covered within floor mat 100. This type of selectability is known in other mediums where selectivity between a variety of different graphics within a common display panel is desired. For example, advertising bulletin boards at sporting events are able to selectively display a first particular message during a first particular period of time and display a second message during a second period of time on the same bulletin board.

A third possible alternative is to provide a modifiable display on the floor mat. The display surface can be associated with either the base portion or the insert portion, e.g., on either the bottom surface of recess 210 or attached to the bottom of insert portion 300. A display could be included on the front of the floor mat, on the back of the mat such that it is viewable through a transparent portion of the mat, embedded in the mat, attached to the mat, or integrally formed in the mat. For example, the display could be comprised of a small, thin box of graphics that could attach to a tacky portion and/or a base portion or any other component part of the floor mat. However it is associated with the floor mat, a user may design and display their customized graphic and may subsequently modify that graphic such that it is replaced with another graphic. A display surface such as an erasable writing board could be utilized for this purpose.

It is also contemplated that a modifiable electronic display surface could be provided, such as, for example, a liquid crystal display. The display could be connected to a computer and a computer generated image could be displayed on the display. Thus, the image displayed on the display could be modified by generating a different computer image and displaying that computer image on the display. The display could be associated with base portion 200, such as included within recess 210, or could be included on a bottom surface, facing upward, of insert portion 300. Alternatively, the display could be integrally formed with either of the base portion or the insert portion. The modifiable display could utilize a plurality of different graphics that can be displayed in any of a variety of manners on the display. For example, the graphics could be displayed in a generally fixed position on the display or could scroll across the display, with both exemplary methodologies displaying multiple graphics either individually or in combination.

Other alternatives for modifying the graphics 220 of floor mat 100 include using light emitting polymers to create, and thus change, graphics 220. The light emitting polymers can be either applied to, attached to, or woven into the floor mat. The light emitting polymers may be utilized on any portion of floor mat 100, for example, on either the base portion or the insert portion, or on any other portion of the different embodiments for the floor mat. Light emitting polymers are known and described in U.S. Pat. Nos. 5,945,502, 5,869,350, and 5,571,626, which are incorporated herein by reference in their entirety.

Other options for a display are to use electronic ink or electric paper. Electric paper is available from Xerox and is described in U.S. Pat. Nos. 5,723,204, 5,604,027, 4,126,854, and 4,143,103, which are incorporated herein by reference in their entirety. Electric paper employs thousands of tiny, electrically charged beads, called Gyricon, each about the width of a human hair, to create pixels. The two-tone beads are embedded inside a liquid-filled plastic sheeting that forms the surface of the paper. Each bead, half-black, half-white, gyrates in response to an electric field. Whether the beads are black- or white-side up determines the image. Because there's no need to refresh the image, and because the screen isn't backlit, electric paper uses only a fraction of the power used by conventional electronic displays. Electromagnetic styluses and printer-like devices can be used for getting images onto the paper.

Electronic ink is available from E Ink Corp., at 45 Spinelli PI., Cambridge, Mass. 02138. Electronic ink uses a microencapsulated micromechanical display system. Tiny microcapsules are captured between two sheets of plastic to create pixels. Alternatively, the capsules may be sprayed on a surface. The result is a flexible display material. The tiny capsules are transparent and contain a mixture of dark ink and white paint chips. An electric charge is passed through the capsules. Depending on the electrostatic charge, the paint chips float at the top or rest on the bottom of each capsule. When the paint chips float at the top, the surface appears white. When they rest at the bottom, and thus under the ink, the surface appears black. Each of the two states is stable: black or white. A transparent electromagnetic grid laid over the sheet's surface controls the shape of the image. The display may be wirelessly connected to, for example, a computer and thus, the World Wide Web by utilizing, for example, a Motorola paging system. Text on all displays, if multiple displays are used, can be changed at once by a single editor, through a Web page.

Again, a display, which could utilize any of the methods discussed above for modifying the display, could be associated with any portion of the floor mat, such as base portion 200 within recess 210 or on a bottom surface, facing upward, of insert portion 300. Alternatively, the display could be integrally formed with either of the base portion or the insert portion. The display could be utilized in any of the embodiments disclosed herein for the floor mat of the present invention, including a floor mat that includes a tacky surface and a non-tacky floor mat embodiment.

In further describing base portion 200, as mentioned above, base portion 200 may also include both a water dissipation component and a cushioning component. The water dissipation component provides for transferring moisture from the soles of a person's shoes that is standing on floor mat 100 to reduce the degree of moisture transferred to cleanable insert portion 300 and the cushioning component provides for conforming the floor mat 100 to the shape of the person's soles such that a greater amount of the debris on the person's soles may be removed by floor mat 100. The present invention is not limited to any particular structure or material for the water dissipation component and the cushioning component. For example, the water dissipation component may be comprised of any of a wide variety of known materials, such as polyamides, vinylics, and polyisoprene. It is desirable, but not required, that the water dissipation component dissipate or move the water and not retain the water. Thus, porous materials, and not hydrophilic materials, are desired. The cushioning component may be comprised of any of a variety of cushioning components to include, for example, foam rubber.

FIG. 2 also further illustrates cleanable insert portion 300. As can be seen, cleanable insert portion 300 has a geometric shape which is complementary in size and form to the recess 210 that is formed within base portion 200. As such, cleanable insert portion 300 is able to be received securely within recess 210. Thus, cleanable insert portion 300 has a length L₂ which is just slightly smaller than the length L₁ of recess 210. Likewise, cleanable insert portion 300 has a width W₂ which is also just slightly smaller than width W₁ of recess 210.

On the bottom side 310 of cleanable insert portion 300, i.e., that surface which contacts the surface which defines the bottom of recess 210, an attachment mechanism may be provided such that cleanable insert portion 300 may be removably attached to base portion 200 within recess 210. Any of a variety of different attachment mechanisms may be provided on the bottom surface of cleanable insert portion 300 to include, for example, a hook and loop fastener assembly or an adhesive. Regardless of the particular securement mechanism used to removably attach cleanable insert portion 300 to base portion 200, in this embodiment, cleanable insert portion 300 may be removed from base portion 200 such that it may be cleaned by a user and, after cleaning, be reinserted within recess 210 such that a clean surface is now provided for floor mat 100.

As stated above, cleanable insert portion 300 may be formed from a transparent material such as hydrophilic aliphatic acrylic polymers and copolymers incorporating acrylic acid, hydroxy ethyl methacrylate, and glycerin monomethacrylate. Forming cleanable insert portion 300 of a transparent material would allow an individual to view the customized graphics that may be provided within floor mat 100, as discussed previously. Alternatively, the insert portion 300 could be opaque.

Additionally, the top side of cleanable insert portion 300 may include a tacky surface. The tacky surface would provide for assisting in removing debris from the soles of a person's shoes that is standing on cleanable insert portion 300. When the top tacky surface of cleanable insert portion 300 is dirtied to such an extent that the user desires to clean insert portion 300, in this embodiment, the user removes insert portion 300 from base portion 200 and cleans insert portion 300 to remove the accumulated debris. The insert portion 300 is then reinserted into base portion 200.

The tacky surface that is provided on the top side of cleanable insert portion 300 could be comprised of any of a variety of materials, such as polyvinyl chlorides combined with a suitable plasticizer, plasticized neoprene, polysulfides, and polyurethanes. Additionally, acrylics, such as butyl acrylate and many of its homologues, may be utilized. Again, the present invention is not limited to any particular material. The tacky surface may be formed, generally, from any adhesive material. The only consideration, in this embodiment, is that the surface should maintain its tacky characteristic even after repeated cleaning cycles.

The present invention is not limited to any particular methodology for cleaning insert portion 300. Insert portion 300 may be cleaned by any of a variety of methods depending upon a particular material composition for insert portion 300. For example, insert portion 300 may be cleaned by placing insert portion within a washing machine and washing insert portion 300 or insert portion 300 may be cleaned by scrubbing insert portion 300 with a scrub brush and soap and water or with a cleaning agent such as “Spic 'N Span”.

Additionally, the insert portion 300 could be cleaned by utilizing a roller that also includes a tacky surface around the circumference of the roller. The tacky surface of the roller is comprised of a stronger adhesive than that of the tacky insert portion such that, as the tacky surface of the roller is rolled over the tacky surface of the insert portion, any dirt and debris on the tacky insert portion will be drawn off of the tacky insert portion and will adhere to the roller. In this manner, a roller with a tacky surface could be utilized to clean the tacky insert portion.

Again, however, the present invention is not limited to any particular methodology or cleaning agent for cleaning insert portion 300 and any cleaning methodology or agent compatible with the composition of insert portion 300 is contemplated.

Floor mat 100 may also include additional features for assisting in the cleaning of the soles of a person standing on floor mat 100. For example, base portion 200 and/or insert portion 300 may include an antibacterial composition and an antifungal composition. Antibacterial compositions such as anthraquinone derivatives of polyethylene glycol mono- and di-methacrylate could be utilized. Thus, floor mat 100 would be bactericidal. The antibacterial feature would be particularly desirable because the floor mat would be able to both clean structural debris from the soles of the person's shoes and remove any potentially harmful bacteria from the person's soles as well.

Additionally, in order to further provide for a desirable sole surface prior to entering a particular area, floor mat 100 could also be provided with a fragrance. Flavones such as tricyclic molecules with aromatic substitution or organic ethers, e.g., liminolic acid, could be utilized. The fragrance is transferred from floor mat 100 to the soles of the person's shoes such that any undesirable odors are favorably masked by the fragrance.

The present invention is not only limited to utilizing an antibacterial composition, an antifungal composition, and/or a fragrance in floor mat 100. Rather, floor mat 100 could also incorporate a variety of other substances that would assist in cleaning the soles of a person's shoes.

Any variety of structures or methods could be utilized for associating an antibacterial composition, an antifungal composition, a fragrance, or any other composition, with floor mat 100. The substances could be applied as releasable, or dissipatable, coatings to floor mat 100 or could be releasably embedded as, for example, pellets within the structure of floor mat 100 such that as pressure is applied to floor mat 100 the substances are dispensed to the soles of the person's shoes.

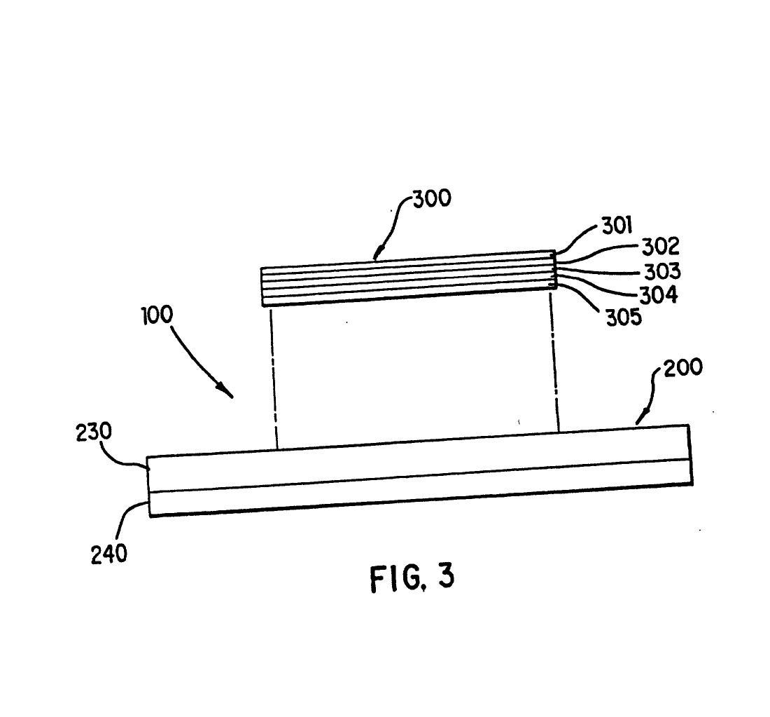

FIG. 3 illustrates an alternative embodiment for floor mat 100. In FIG. 3, it is illustrated that base portion 200 may include separate layers for a water dissipation component 230 and a cushioning component 240. Water dissipation component 230, in this embodiment, is disposed on a top side of the cushioning component 240. However, the present invention is not limited to this particular embodiment for water dissipation component 230 and cushioning component 240. For example, a single hybrid structure could be utilized for base portion 200 that would include the material properties to provide for both water dissipation and conforming structure.

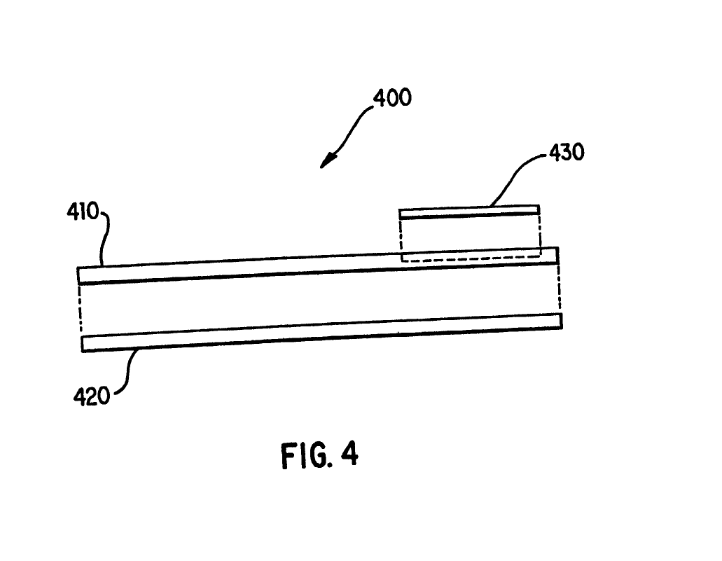

Alternatively, FIG. 4 illustrates that the floor mat may include both a water dissipation component, or wicking layer, and a water absorbtion layer. In FIG. 4, floor mat 400 includes wicking layer 410 and water absorption layer 420. The wicking layer 410 could be comprised of polypropeline or olefins, or any other suitable material that has the properties of moving the water from the surface of floor mat 400. The water absorption layer 420 is disposed underneath the wicking layer 410 and absorbs any water that passes through the wicking layer 410. The water absorption layer 420 could be periodically removed and dried, such as by example only, in a drying machine.

Of course, a wicking layer 410 may be used either with or without a water absorption layer 420 and a cushioning layer, as described previously in other embodiments, and the water absorption layer 420 could be used with or without a wicking layer 410 and a cushioning layer. Additionally, both the wicking layer and/or the absorption layer and/or the cushioning layer could be used with or without a tacky portion.

Returning to FIG. 3, FIG. 3 also illustrates an alternative embodiment for insert portion 300. Whereas the previously disclosed embodiment for insert portion 300 was discussed as a single structural member that could include a tacky surface on a top side thereof, the embodiment of FIG. 3 for insert portion 300 is comprised of a plurality of layers. As can be seen, layers 301-305, comprise insert portion 300. Each of the layers may include a tacky surface on a top side thereof, as was described previously for insert portion 300. In use, a top-most layer, e.g., layer 301, may be removed from its adjacent lower layer, e.g., layer 302, and may be independently cleaned. After cleaning, the layer may be reinstalled within recess 210 on top of the exposed layer of insert portion 300. In this manner, insert portion 300 may be cleaned by removing a top-most layer, cleaning that layer, and reinstalling that layer within recess 210. Whereas each layer is described as being independently cleanable, it is not required that each individual layer be cleanable. Each layer may be formed of materials as described previously when discussing the embodiment of FIGS. 1 and 2 for the insert portion.

Other alternative embodiments for insert portion 300 are contemplated. For example, whereas the previously disclosed embodiments discussed insert portion 300 as being comprised of one or more layers with a tacky surface on a top side of the layer(s), it is not required that insert portion 300 be formed with only a tacky surface on a top side thereof. More specifically, an alternative embodiment for insert portion 300 could include forming insert portion 300 as a single structural member from a material which is tacky in composition throughout the entire cross-section of the material. A material such as a blend of a noncross-linked hydrophilic thermoplastic, preferably a polyethylene glycol diacrylate with n not exceeding 15, and a hydrophobic material, such as a polyvinyl neoprene chloride, could be utilized for the insert portion of this embodiment. By forming insert portion 300 from a uniform, tacky material, the insert portion 300 does not necessarily have to be removed from recess 210 of base portion 200 to be cleaned. Insert portion 300 could be cleaned in this alternative embodiment by eroding the top surface of the insert portion as a result of use of the insert portion. Thus, by providing an erodible insert portion, the insert portion may be cleaned by the erosion of its top surface as the insert portion is used within floor mat 100.

As insert portion 300 erodes, the exposed surface of insert portion 300 continues to be tacky in composition because of its uniform cross-section. As the exposed tacky surface erodes, the dirt captured by the exposed tacky surface will dissipate as a result of the erosion and thus, the erosion of the insert portion itself provides for a cleanable insert portion.

Alternatively, even with a uniform cross-section of a tacky substance for insert portion 300, the user may remove insert portion 300 from recess 210 and separately clean insert portion 300. Thus, the user is not required to rely solely on the erodible characteristic of insert portion 300 for cleaning of insert portion 300; rather, the user may utilize the erodible cleaning feature of the insert portion in combination with a separate cleaning step of removing the insert portion from the base portion and independently cleaning the insert portion.

As discussed above, insert portion 300 may be comprised of a variety of materials, including materials such as tacky plastics, paper, or adhesives that can be cleanable and may or may not be erodible and reusable. If paper is utilized, the insert portion may be formed as a single structural member or as a plurality of layers, as discussed previously. Additionally, the paper may include a tacky surface on a top-side thereof. The paper may be translucent, opaque, or colored, and may include a graphic display thereon.

As discussed earlier, it is desirable, but not required, that the floor mat contain a water dissipation and/or absorption capability. This capability is desired to help prevent the tacky surface of the insert portion from becoming excessively wet and, thus, slippery. Whereas it has been discussed that, in order to help prevent a user from slipping on the tacky surface of the insert portion, a water dissipation and/or absorbing capability could be included in the floor mat to reduce the degree of moisture on the tacky surface, this is not the only structure contemplated for preventing the tacky insert portion from becoming slippery. Alternatively, the tacky insert portion itself could be formed to help prevent slipping. FIGS. 5-12 illustrate alternative embodiments for tacky insert portion 300. FIG. 5 illustrates tacky insert portion 300 as including a grid pattern 320 of channels 322 that could be comprised of a non-tacky material. The channels could be either raised from the surface of insert portion 300 or could lie co-planar with the top surface of the insert portion. By forming the channels of a non-tacky material, even if the tacky material of insert portion 300 became wet, a user would be assisted in not slipping on the slippery, wet tacky surface of the insert portion by the presence of the non-tacky surfaces which do not become slippery when wet.

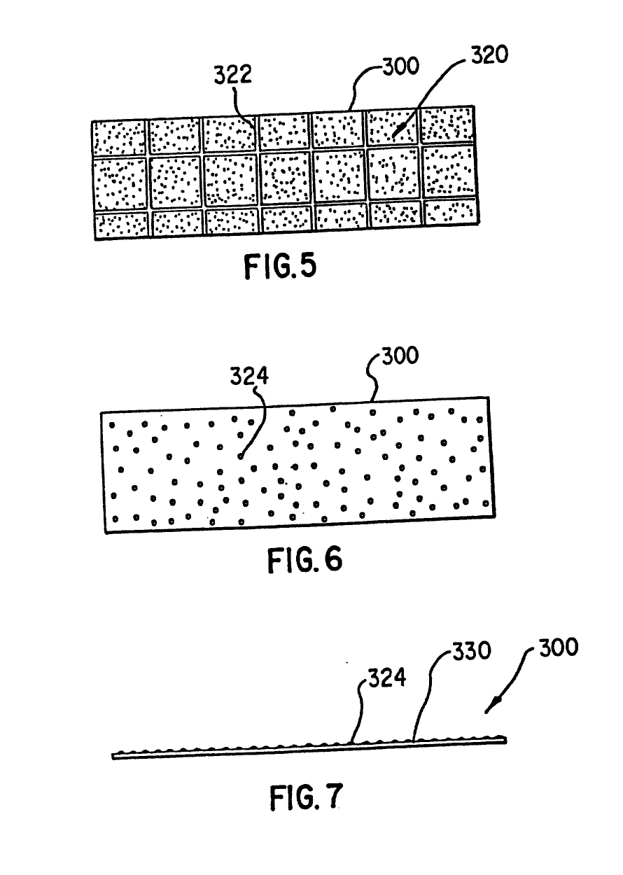

FIGS. 6 and 7 illustrate another alternative embodiment for tacky insert portion 300 which includes anti-slip particles 324, e.g., silicon or sand particles, which extend above the top surface 330 of the tacky insert portion. It is desirable that the anti-slip particles be comprised of a material that does not become slippery when wet and that they be exposed from the tacky surface, however, it is not required. Even if the anti-slip particles are embedded within the tacky surface, their extension above the top surface 330 of the tacky insert portion will provide a physical frictional restraint against slipping for the soles of a person's shoes who is standing on the floor mat.

Whereas FIG. 5 illustrates tacky insert portion 300 as including a grid pattern 320 of channels 322 that could be comprised of a non-tacky material and FIGS. 6 and 7 illustrate another alternative embodiment for tacky insert portion 300 which includes anti-slip particles 324 which extend above the top surface 330 of the tacky insert portion, it is not required that these two alternative embodiments contain features that are mutually exclusive. For example, it is contemplated that tacky insert portion 300 could include both a grid pattern of non-tacky channels and anti-slip particles, which is not illustrated specifically in the Figures but which can be easily understood.

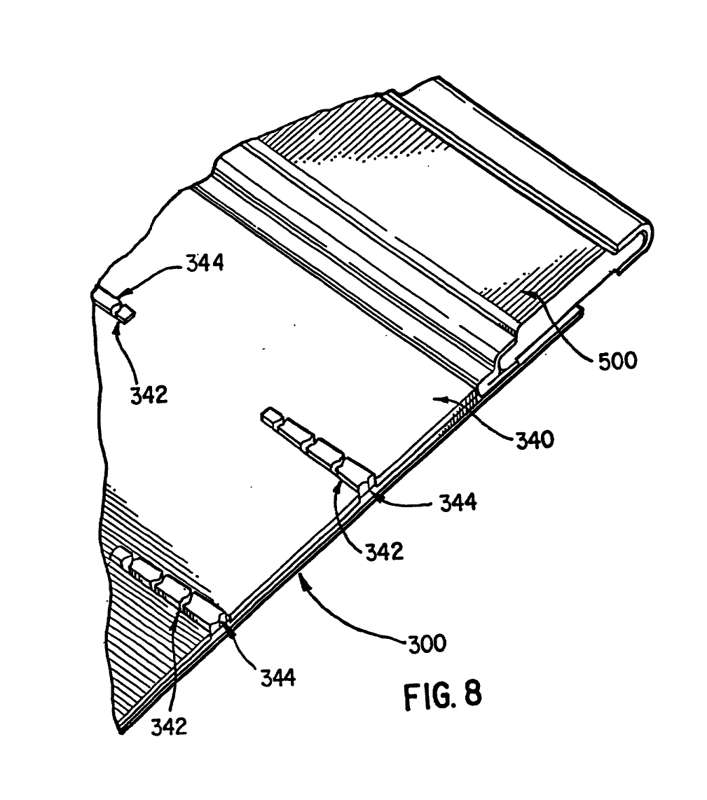

Another alternative for providing a slip-resistant tacky portion is to include a plurality of anti-slip members, or treads or nipples, that extend up through and slightly above the surface of the tacky portion. As can be seen in FIG. 8, in this embodiment, tacky portion 300 is inserted within a base portion, which may be a water absorbent border 500, and includes a plurality of apertures 342 within it. Each of a plurality of treads 344, which may extend upward from a base disposed underneath tacky portion 300, extend up through one of the plurality of apertures 342. A top-most end of each tread extends above a top-most surface 340 of tacky portion 300. As a person steps onto tacky portion 300, the quantity and positioning of the treads 344 is such that the tacky portion is able to remove debris from the person's shoes and the treads 344, at least one of which is stepped upon by the person, prevents slipping of the person on the tacky portion 300 should the tacky portion 300 become slippery when wet. The treads 344 may compress when stepped upon such that the top-most end of the tread is co-planar with the top-most surface 340 of the tacky portion 300. In this manner, the tread will contact the person's shoes to prevent slipping but yet not hinder contact between the person's shoes and the tacky surface of the mat, which enhances the cleaning of the person's shoes. Therefore, there is a relationship between the distance that the tread extends above the top-most surface of the tacky portion and the compressibility of the tread; a relationship which provides the functionality discussed above.

The treads may be configured in any shape and size. Additionally, the treads may be comprised of any material which is slip-resistant when wet, such as, for example, rubber or plastics. The treads may include grooves within them to further assist in preventing a person from slipping on the tacky portion.

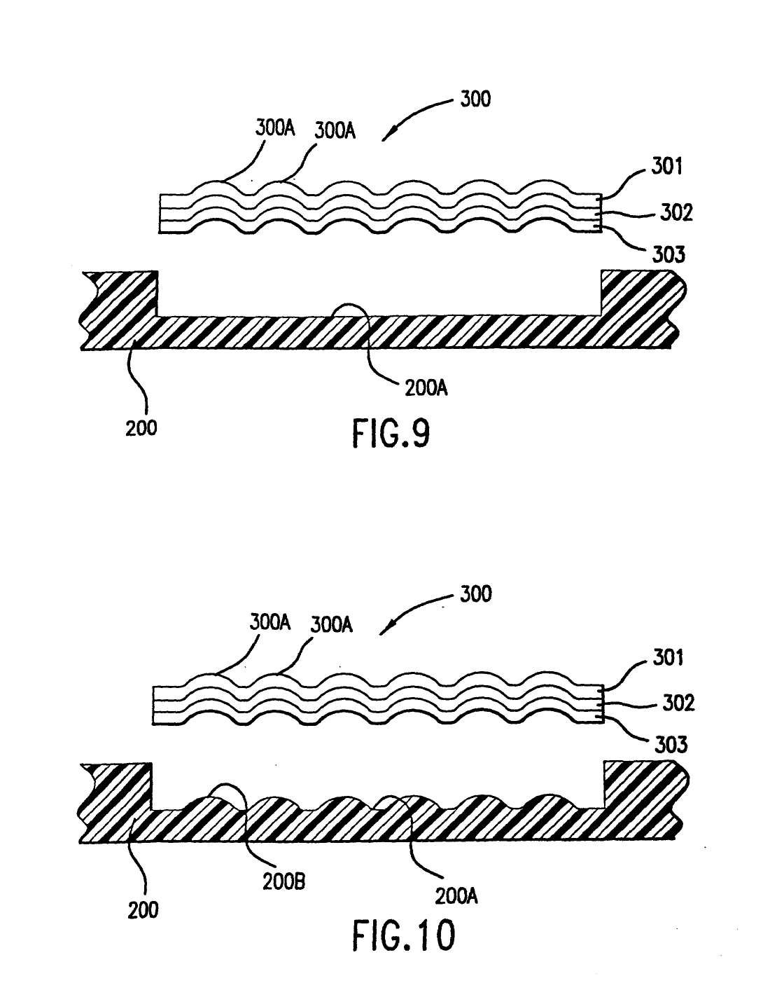

FIGS. 9 and 10 illustrate additional alternative embodiments for both the tacky insert portion 300 and the base portion 200 that help to prevent slipping on a potentially wet tacky portion. As can be seen in FIG. 9, and as discussed previously, tacky insert portion 300 is comprised of a plurality of layers 301, 302, and 303. Whereas only three layers are illustrated, it can be understood that any number of layers can be utilized in the present invention. As can be seen, tacky layers 301-303 each contain a plurality of integrally formed raised portions 300A. These raised portions can help to prevent a person from slipping on the tacky portion by providing increased friction between the top surface of the tacky layer, due to the raised portions, and the person's shoes. Thus, these raised portions can substantially reduce the potential for slipping on the tacky portion if it becomes wet.

The raised portion 300A can be formed in each layer in a variety of ways and the present invention is not limited to any particular method. One method for forming the raised portions is to assemble the layers into a pad of layers and then insert the entire pad into a machine press. One face of the press is flat and the other face, i.e., that face that is facing the non-tacky, or underside, of the layers, contains an array of bosses or bumps. When the pad is pressed in the machine press, all of the tacky layers become embossed with the pattern on the press face, causing the raised portions, or embossed portions, in each tacky layer of the pad. Thus, each embossed portion is integrally formed in each layer and is comprised of an indentation on the underside, or non-tacky side, of each layer and a raised portion on the upperside, or tacky side, of each layer.

As can be understood, in the method as described above for forming the raised portions, the raised portions of each layer are aligned with the raised portions of each other layer. It is desirable, but not required, that the raised portions of each layer are aligned so that their shape may be easily maintained when the layers are stacked one upon another.

As can be seen in FIG. 10, base portion 200 may also be formed to be complementary to the embossed layers. The surface 200A that defines a bottom of the recess of base portion 200, which receives within it the tacky layers 300, can be formed with raised portions 200B. These raised portions are positioned so that they are aligned with the raised portions in the tacky layers. Thus, the raised portions 200B on surface 200A are positioned within the indentations in the lower-most tacky layer when the layers are inserted into the recess in the base portion. As can be understood, these raised portions help to retain and maintain the raised portions in the tacky layer(s), particularly when only the lower-most layer(s) remain in the floor mat. However, it is not required that the base portion be formed with raised portions in practicing the present invention. The layers may be formed with raised portions whether or not the base portion includes complementary raised portions.

In another alternative embodiment for a tacky portion, the tacky portion could also include a water dissipating capability. The tacky portion could be comprised of a hydrophobic porous structure which would assist in dissipating water from the surface of the tacky portion.

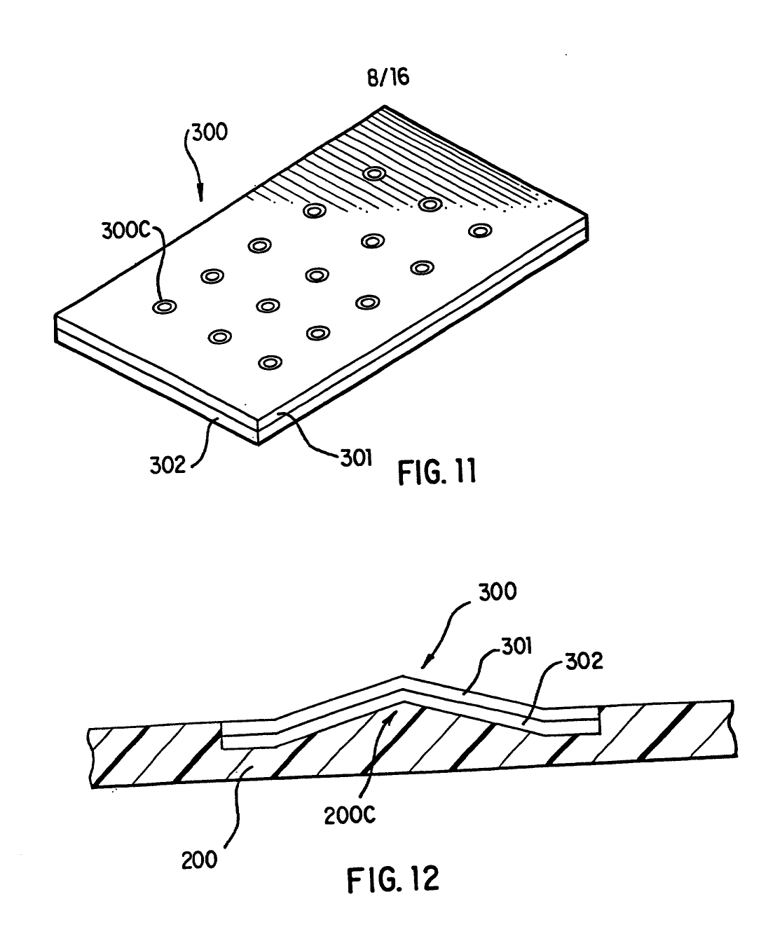

FIGS. 11 and 12 illustrate alternative embodiments for the floor mat of the present invention that provide a water dissipating capability for the tacky portion. As will be discussed, the embodiment of FIG. 11 also helps to prevent a person from slipping on a potentially wet tacky portion.

FIG. 11 illustrates an embodiment for tacky portion 300 where the tacky layers 301 and 302 of the tacky portion define a plurality of apertures 300C therein. The apertures of each layer are aligned with the apertures of each other layer. Thus, because of the aligned apertures in the layers, the tacky portion is able to drain surface water from the top-most surface of the tacky portion, or from the soles of a person's shoes that is standing on the tacky portion, through the apertures and to the base portion, within which the layers may be positioned. The base portion, as discussed previously, may include a water dissipation component and/or a water absorbing component which would move and/or absorb the surface water drained from the tacky portion through the apertures.

The apertures would also provide for helping to prevent slipping on a wet surface of the layers, not only by draining surface water from the surface, but by also providing for enhanced frictional contact between the shoes of the person stepping on the layer and the layer itself. The apertures provide for discontinuities in the surface of the layer which would enhance the frictional contact between the person's shoes and the layer. The edges of the surface of the layer which define the apertures would provide for this enhanced contact. The person's shoes would engage with the edges, thus enhancing frictional contact for the shoes. Additionally, the apertures would act as a suction on the bottoms of the person's shoes, e.g., like suction cups. This suction caused by the apertures on the person's shoes would also help to prevent slippage on the surface of the layer.

FIG. 12 illustrates another embodiment for the floor mat of the present invention that also provides a water dissipating capability for the tacky portion. As can be seen, tacky portion 300 includes layers 301 and 302. Base portion 200 defines a recess where layers 301 and 302 are disposed within the recess. A surface of the base portion that defines a bottom of the recess includes a raised portion 200C at or near a center position within the recess. Thus, the raised portion 200C of the base portion forms a raised portion in each of the layers. As can be understood, the raised portion formed in the layers acts to dissipate surface water on the layers from the layers. The surface water will drain off of the layers under the force of gravity due to the raised portion.

Again, any number of layers may be included in tacky portion 300 in the embodiments of FIGS. 11 and 12.

It is also contemplated that a water absorbing powder, such as a talcum powder, could be provided in the present invention. The powder could either be integrated into the floor mat or be separately associated with the floor mat. The talcum powder would remove moisture from the soles of a person's shoes when the person stepped into the powder and the tacky insert portion could then remove the powder from the person's soles, in addition to any dirt on the soles, when the person next steps on the tacky insert portion.

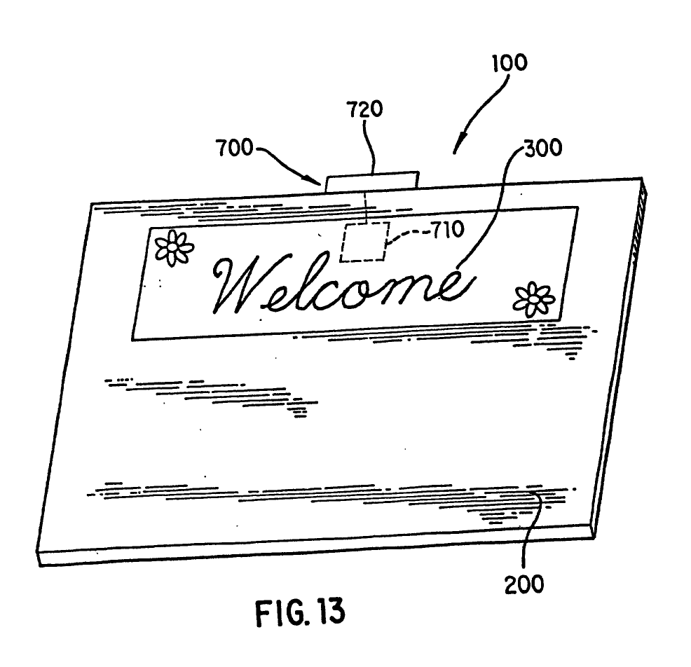

The present invention also provides an apparatus and method for determining when the tacky portion, or a layer in the tacky portion, should be removed for cleaning. Since the tacky portion assists in removing dirt from the soles of the person's shoes that steps on the tacky portion, the tacky portion, or a layer thereof, will become dirty after some number of persons step on the it, assuming that any particular person's shoes are not exceptionally dirty. Therefore, it would be desirable to assist a person in deciding when to remove a dirty tacky portion for cleaning. Again, as discussed above, this determination can be made after a certain number of persons step on the mat. Thus, an embodiment of the present invention as illustrated in FIG. 13 includes a sensor system 700 that detects the presence of a person on the floor mat 100. The sensor system 700 may detect the presence of a person on base portion 200 and/or tacky portion 300. Since it is assumed that a person who steps on base portion 200 will also step on tacky portion 300, sensing the person's presence on either portion is sufficient for practicing the present invention.

Sensor system 700 includes a sensor 710 and a display device 720, e.g., an LED, coupled to sensor 710 and disposed on mat 100 such that it can be viewed. A power source, such as a battery, may be included on an underside of the floor mat. As mentioned above, sensor 710 senses the presence of a person on mat 100, e.g., in this embodiment on tacky portion 300. The sensor can detect the person's presence by utilizing any of a variety of apparatuses and methods and can include sensing the pressure applied to the mat by the weight of the person standing on the mat or by sensing the motion across the surface of the mat by the movements of the person. Thus, pressure sensors and motion detectors may be utilized in the present invention. Sensor system 700 also determines the number of persons that have stepped on the mat 100 by counting the number of sensed presences. After the number of presences equals a defined number of presences, a signal is provided to display device 720, e.g., illuminating the LED, which indicates that the tacky portion should be removed for cleaning. The present invention is not limited to removing the tacky portion at any particular number of sensed presences and the number may be adjusted based on the particular environmental conditions in which the mat is utilized. Of course, as can be understood, after the dirty tacky portion or layer is removed and/or cleaned the sensor system can be reset to begin counting the total number of presences on the newly cleaned or exposed layer.

Alarm device 720 can provide either a visual, audible, or vibratory signal and the present invention is not limited to providing any particular type of signal. For example, a visual signal could consist of a light that is illuminated when the floor mat should be cleaned and that is not illuminated when the floor mat does not require cleaning. Alternatively, the light could be continuously illuminated in one of a plurality of different colors, with each color signifying a different state of cleanliness for the floor mat. For example, a green light could signify that the mat does not need cleaning. A yellow light could indicate the mat is reaching a state of dirtiness that will soon require cleaning. A red light, which could blink on and off, could signify that it is time to clean the floor mat.

The sensor system of the present invention may be utilized with any of the embodiments disclosed for the cleanable portion, which may or may not be an insert and may or may not include layers and a tacky surface(s), and the base portion.

Whereas cleanable portion 300 has been discussed as an insert portion, it is not required that cleanable portion 300 be inserted into floor mat 100. There exists many alternative possibilities for associating cleanable portion 300 with floor mat 100. For example, cleanable portion 300 could be placed on top of base portion 200 or could be positioned adjacent to base portion 200. The present invention is not limited to inserting any of the embodiments for cleanable portion 300 within base portion 200.

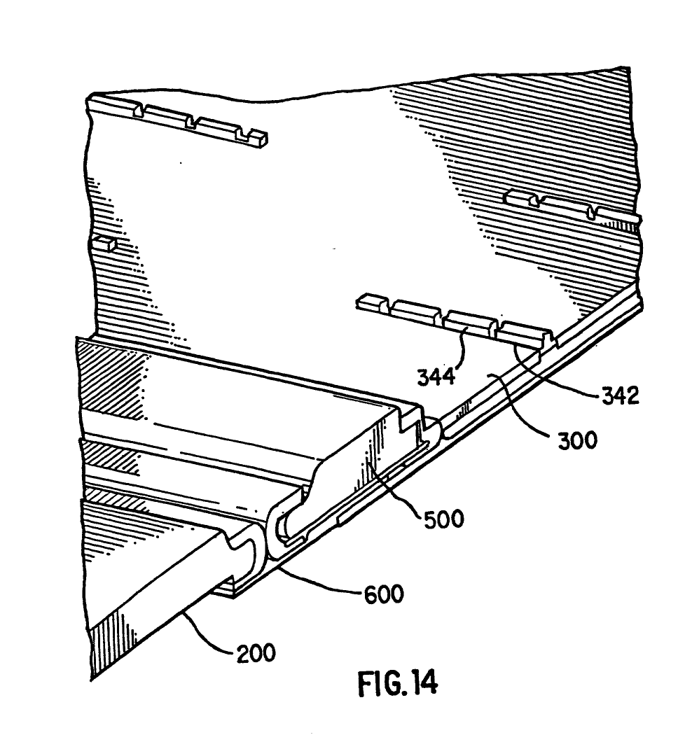

For example, FIG. 14 illustrates a tacky portion 300 and a non-tacky portion 200, which may include a water dissipation component, a water absorbing component, and a cushioning component, as discussed previously, that are separable. As can be seen in FIG. 14, tacky portion 300 may be bordered within a border 500, which may be water absorbent, water dissipative, and include a cushioning component, and may include a plurality of apertures 342 and treads 344 within it. Tacky portion 300 can include any of the embodiments previously discussed. An attachment layer 600 is positioned on an underside of both border 500 of tacky portion 300 and non-tacky portion 200. The border 500 and/or non-tacky portion 200 may be releasably attached to attachment layer 600. Thus, through attachment layer 600, border 500, and therefore tacky portion 300, and non-tacky portion 200 are releasably attachable to each other. In this manner, it is possible to, for example, position non-tacky portion 200 outside of a person's home on the front porch and tacky portion 300 within the person's home.

Attachment layer 600 can be any of a variety of materials. All that is required is that the attachment layer be able to releasable join one portion of the floor mat to a second portion of the floor mat. For example, a hook and loop fastener assembly, e.g., Velcro®, can be used with one portion of the assembly on the attachment layer and the other portion on the underside of the first portion of the floor mat and the second portion of the floor mat. Alternatively, an adhesive can be utilized to releasably join the two portions of the floor mat to the attachment layer. Additionally, snaps, including any type of male/female connector, may be used to join the two portions to the attachment layer.

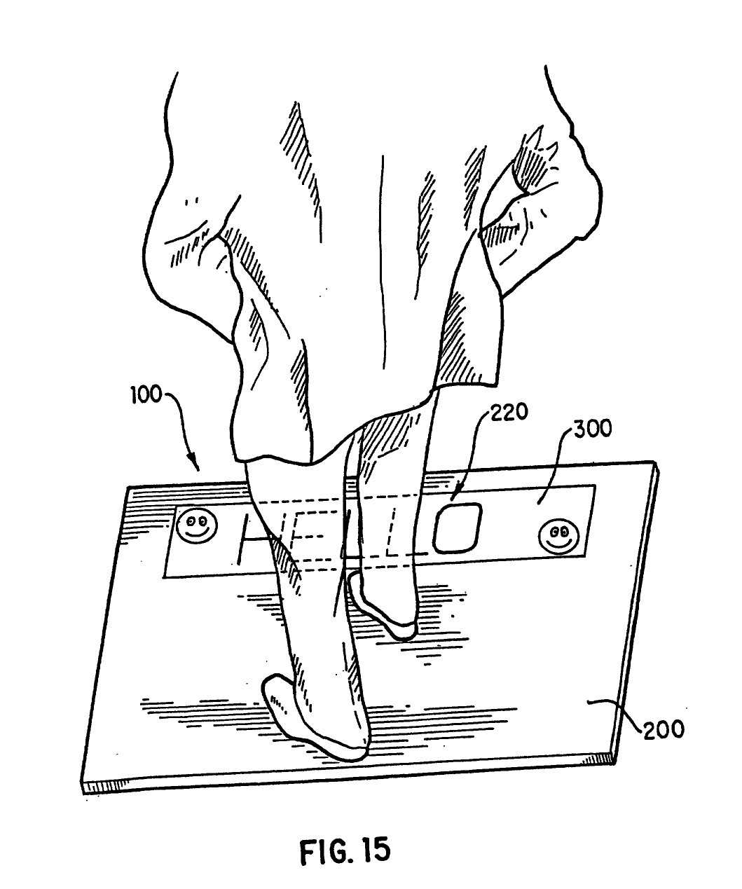

FIG. 15 illustrates a first process step in utilizing an embodiment of the floor mat 100 of the present invention. As was described previously, an embodiment of floor mat 100 includes a base portion 200 and an insert portion 300. As can be seen in FIG. 15, and as was also discussed previously, a different graphic display 220 is present in the embodiment of FIG. 15 than was illustrated in the embodiment of FIGS. 1 and 2. Thus, FIG. 15 displays a “Hello” message with “smiley face” representations in the graphic 220.

As can be seen in FIG. 15, in utilizing an embodiment of the present invention, a user would first step upon base portion 200. As discussed earlier, base portion 200 may include a water dissipating and/or absorbing component and is thus able to assist in removing any moisture from the soles of the person's shoes. As was also discussed earlier, because base portion 200, in one embodiment, also includes a cushioning component, base portion 200 conforms to the person's soles when the person steps upon base portion 200. Whereas not illustrated in FIG. 15, as discussed previously, an antibacterial composition, an antifungal composition, a fragrance, or any other cleaning substance may also be associated with floor mat 100 and applied to the soles of the person's shoes when the person applies pressure to floor mat 100.

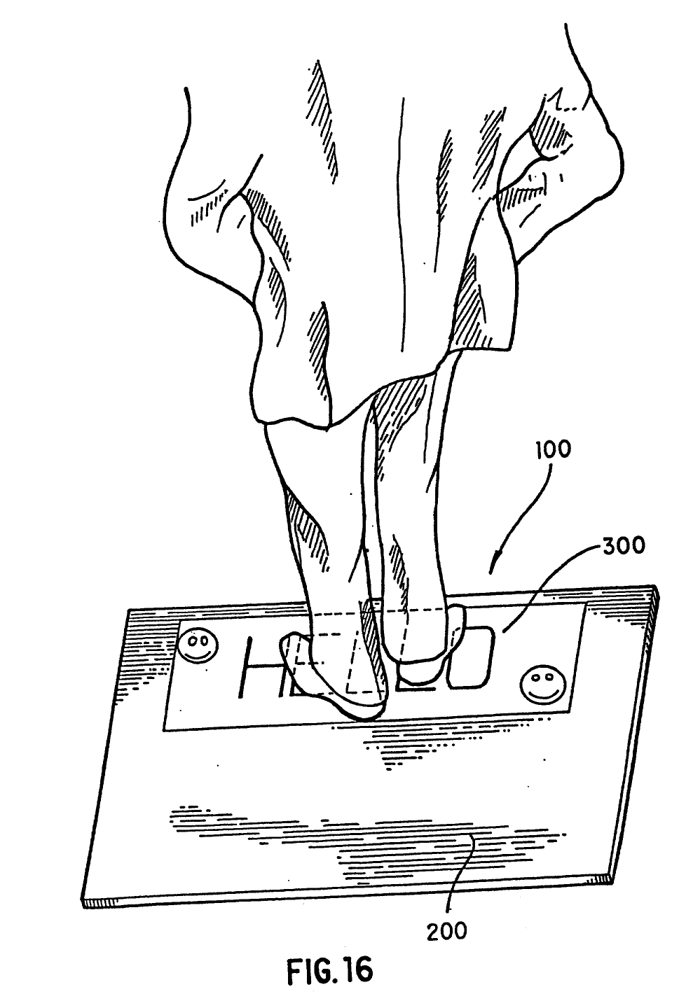

As can be seen in FIG. 16, the second process step in utilizing the present invention includes the person stepping onto insert portion 300 of floor mat 100. As discussed previously, insert portion 300 may include a tacky surface on a top side thereof for assisting in removing debris from the soles of the person's shoes. Additionally, antibacterial compositions, antifungal compositions, fragrances, or other cleaning compositions may also be included within insert portion 300 for dispensing to the soles of the person's shoes.

After the person steps onto insert portion 300, the user then steps off of floor mat 100. As described previously, floor mat 100 may be cleaned after an accumulation of dirt on insert portion 300 by any of the methods described previously. Insert portion 300 may be removed from base portion 200 and cleaned, a layer may be removed from insert portion 300 to be cleaned or discarded, or insert portion 300 may be cleaned through erosion of insert portion 300. The present invention is not limited to any particular methodology for cleaning insert portion 300 of floor mat 100.

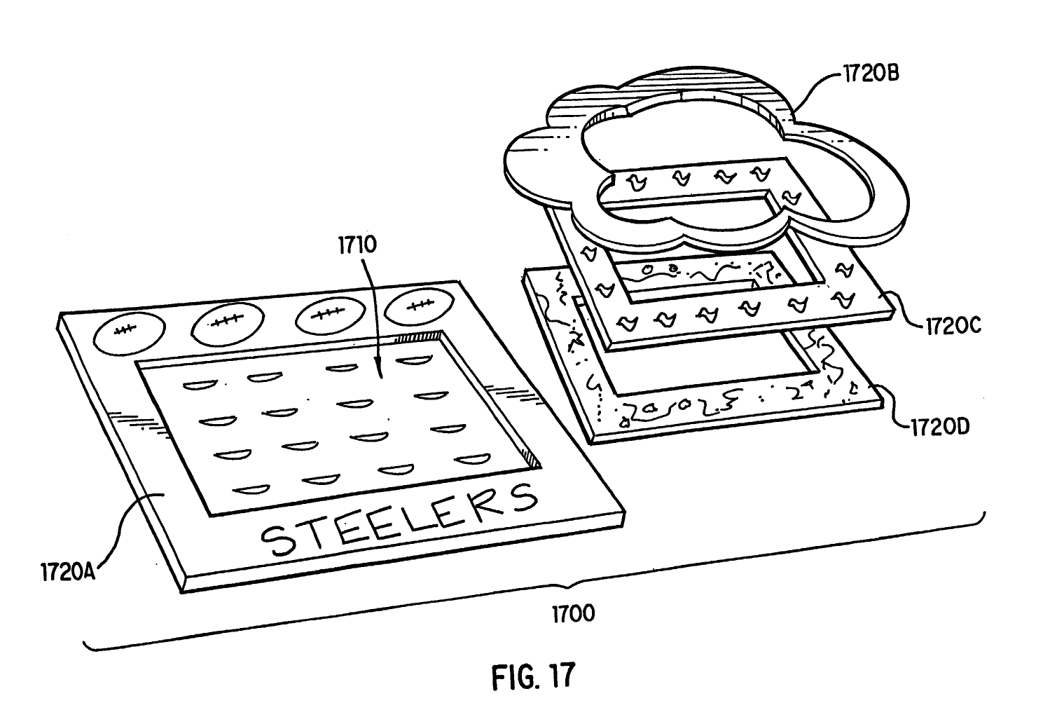

FIGS. 17-22 illustrate further alternative embodiments for the floor mat of the present invention. As can be seen in FIG. 17, in this embodiment for the floor mat, floor mat 1700 includes a cleanable portion 1710 and a plurality of base portions 1720A-D. As can be seen, cleanable portion 1710 is positioned within one of base portions 1720A-D. In this manner, the floor mat 1700 can be customized for a particular user by interchanging the cleanable portion 1710 with one of a variety of base portions 1720A-D. The base portions 1720A-D can be formed in any of a variety of physical configurations and can include any of a variety of themes, graphics, or colors. Thus, a common cleanable portion 1710 may be utilized with a variety of base portions 1720A-D.

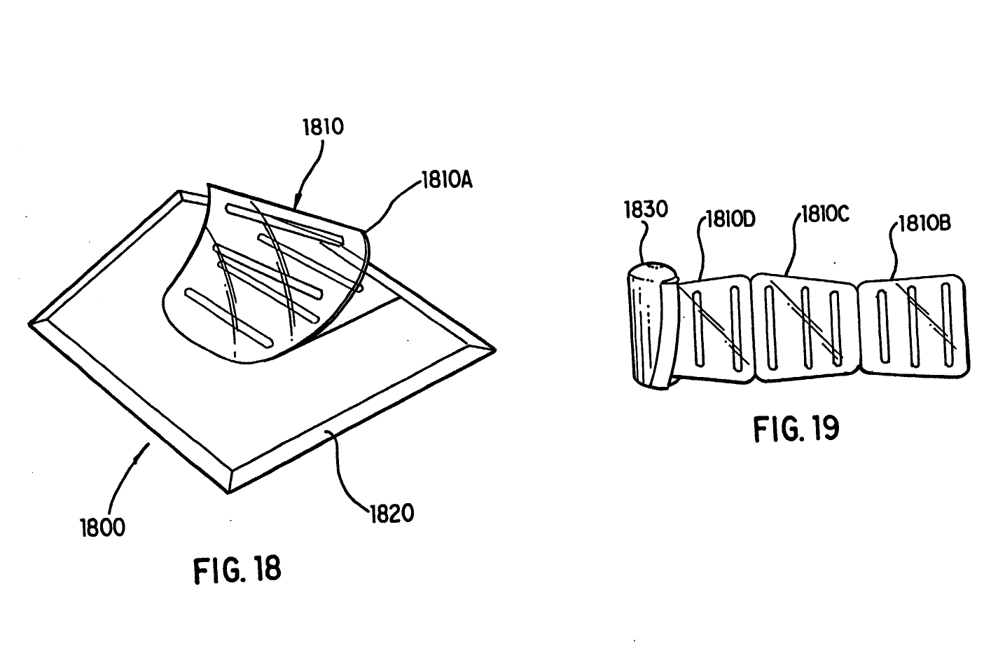

FIGS. 18-20 illustrate another alternative embodiment for a floor mat 1800 in accordance with the principles of the present invention. As can be seen in FIG. 18, floor mat 1800 also includes a cleanable portion 1810 and a base portion 1820. As discussed previously, cleanable portion 1810 is received within base portion 1820. In this embodiment, cleanable portion 1810 is comprised of a single sheet 1810A. The single sheet 1810A may be tacky on a top-side thereof and may include apertures therein to receive anti-slip nipples though it, as was also discussed previously. The single sheet 1810A, in this embodiment, may be removed and replaced with another sheet when dirty.

FIG. 19 illustrates that a plurality of sheets 1810B-D, may be attached to each other and rolled into a roll 1830 of sheets. The sheets can be joined to each other at a perforated joint to provide for ease in separating a sheet from the roll of sheets. As can be understood, a sheet may be separated from the roll of remaining sheets and may be then inserted into base portion 1820.

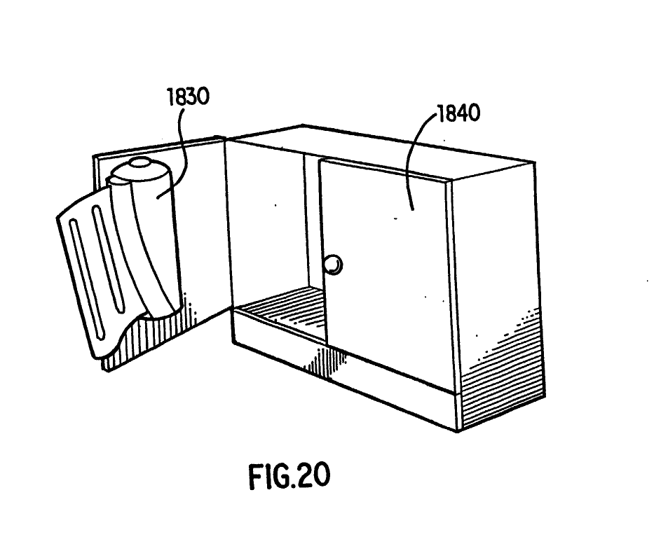

FIG. 20 illustrates that the roll of sheets 1830 may be stored in a storage device 1840, such as, for example, by mounting the roll of sheets 1830 on a cabinet door, which may be located in proximity to the floor mat. In this manner, replacements sheets are easily organized and stored for use.

Alternatively, instead of organizing the sheets in a roll and storing the roll in a cabinet, the sheets could be folder one upon another such that they form a flat package. The package of sheets could then be stored underneath of the floor mat 1800 where individual sheets could be removed from the package and from under the floor mat, when needed, similar to the way a Kleenex® tissue is dispensed.

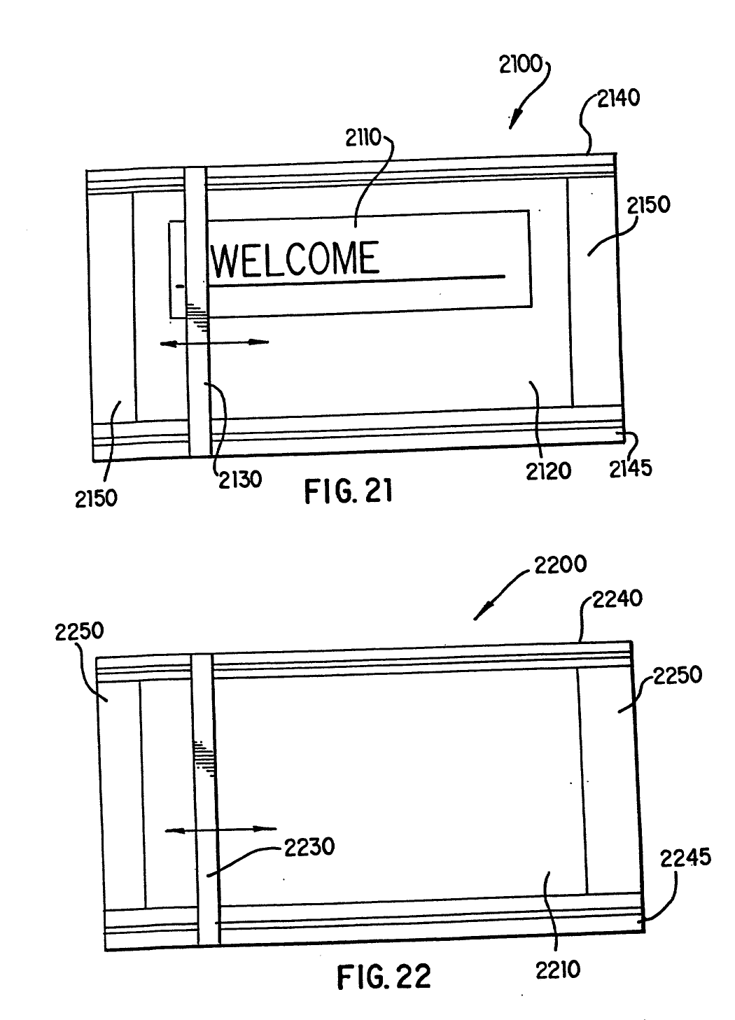

FIG. 21 illustrates another alternative embodiment for a floor mat in accordance with the present invention. Floor mat 2100 also includes a cleanable/scrapable portion 2110 and a base portion 2120. In this embodiment, cleanable portion 2110 is formed, as discussed previously in this application, as a single structural member from a material which is tacky in composition throughout the entire cross-section of the material. As was also discussed previously, by forming portion 2110 from a uniform, tacky material, the portion 2110 does not necessarily have to be removed from the base portion 2120 to be cleaned. However, in the embodiment previously discussed, the cleanable portion 2110 could be cleaned by eroding the top surface of the insert portion as a result of use of the insert portion. In the embodiment of FIG. 21, the cleanable portion is cleaned by scraping off a top surface of approximately 2-3 microns from the cleanable portion 2110 by utilizing a scraper 2130.

Scraper 2130 can include any of a variety of structures, however, all that is required is that the scraper be capable of removing a top surface from cleanable portion 2110. For example, any type of scraping surface can be utilized in scraper 2130, such as, for example, a dull knife, a razor, or a plane.

Scraper 2130 is movable on tracks 2140, 2145. Tracks 2140, 2145 are adjacent to cleanable portion 2110 and base portion 2120. Scraper 2130 may include wheels or other structures, e.g., pins, which are received within complementary structures, e.g., grooves, in tracks 2140, 2145. Thus, scraper 2130 is movable across cleanable portion 2110 on tracks 2140, 2145. The scraper 2130 may only include a scraping surface on the portion of scraper 2130 that is movable across cleanable portion 2110. Additionally, it is not required that two tracks be utilized. The scraper could be movable within a single track.

Scraper 2130 may be moved by any of a variety of methods, including using the foot of a user to engage with the scraper to move the scraper on the tracks.

Floor mat 2100 also includes a catch basin 2150 that may be included at one or both ends of tracks 2140, 2145. Catch basin(s) 2150 includes a recess into which is deposited the shavings from cleanable portion 2110 after scraper 2130 scrapes the cleanable portion. Scraper 2130 moves the shavings off of the cleanable portion and into the catch basin 2150. The shavings from the cleanable portion deposited into the catch basin may be removed from the catch basin in any of a variety of ways, including, for example, by vacuuming the shavings from the catch basin or removing a detachable catch basin, throwing away the contents from the catch basin, and reinstalling the catch basin.

As can be understood, as the cleanable portion is shaved, the scraper is commensurately lowered on tracks 2140, 2145 such that the surface of the scraper that engages with the cleanable portion remains engaged with the cleanable portion. As such, for example, the scraper may be mounted on a ratchet mechanism such that, as the scraper is moved across a complete width of the floor mat, the scraper actuates the ratchet such that the ratchet lowers the scraper. Alternatively, the scraper could remain in the same relative position with respect to the tracks and the tracks could be ratcheted lower with respect to the base portion and cleanable portion. Additionally, the blade surface of the scraper could be lowered with respect to the scraper's structure such that the blade is moved relative to the cleanable portion and the base portion but the scraper remains in the same relative position with respect to the tracks and the cleanable portion and the base portion.

Additionally, it is not required that a base portion be utilized in the embodiment for floor mat 2100. The cleanable portion alone can be utilized with the tracks adjacent the cleanable portion and the scraper movable on the tracks. A catch basin(s) could still be utilized. As such, FIG. 22 illustrates an embodiment for floor mat 2200 that includes a cleanable portion 2210 without use of a base portion. Cleanable portion 2210 is adjacent to tracks 2240, 2245. Scraper 2230 is movable on tracks 2240, 2245. A catch basin 2250 may be included at one or both ends of tracks 2240, 2245.

Thus, as described previously, the floor mat of the present invention includes features as described below. It should be noted that the below-listed features are not all-inclusive of the features of the floor mat of the present invention. This specification in its entirety discloses all of the features of the floor mat of the present invention.

As described previously, in an embodiment, the floor mat includes a tacky surface having a top exposed surface with a surface area and a substantially non-paper anti-slip component disposed within the surface area of the top exposed surface of the tacky surface to prevent slipping on the tacky surface when wet. Thus, the anti-slip component is in operable association with the top exposed surface of the tacky surface to reduce slippage of a person on the top exposed surface who steps on the top exposed surface when the top exposed surface is wet. The anti-slip component may be integrally included in the top exposed surface.

The anti-slip component may include a plurality of channels as can be seen in FIG. 5 which are comprised of a non-tacky material where the plurality of channels is extendible from the top surface of the tacky surface in response to a person stepping on the tacky surface. Alternatively, the floor mat may include an anti-slip component that is extendible from the top surface of the tacky surface in the absence of a person standing on the tacky surface, such as the treads described previously. Thus, the treads may be elongated members that have a length extending across the top exposed surface of the tacky surface which is substantially greater than a height that the treads extend above the top exposed surface of the tacky surface.

Additionally, the anti-slip component may be the apertures illustrated in FIG. 11.

The various embodiments for an anti-slip component may be comprised of a non-tacky material, e.g., non-tacky members, and a water resistant material. Thus, the anti-slip components may be water resistant. The anti-slip components may also be comprised of a material such that they remain functional to prevent slipping on the tacky surface after a plurality of uses. As such, the anti-slip component may be comprised of a sufficiently rigid material such that a configuration of the anti-slip component is substantially maintained after being stepped on a plurality of times by a person and may be comprised of a material having a composition which is substantially maintained after having been stepped on a plurality of times by the person.

As was also described previously, in an embodiment, the floor mat includes a base portion having a non-tacky exposed top surface area 250 or contacting the soles of a person's shoes thereon and a tacky portion associated with the non-tacky exposed top surface area of the base portion and having a tacky exposed top surface area 350 for contacting the soles of the shoes thereon. As can be seen at least in FIG. 1, the base portion non-tacky exposed top surface area 250 is at least as large as the tacky portion tacky exposed top surface area 350.

The floor mat's base portion may include a cushioning component such that when the person's shoes applies pressure to the base portion and the tacky portion, both the base portion and the tacky portion conform to a topography of a bottom of the person's shoes. The tacky portion may also include a tacky surface on a bottom side of the tacky portion.

In various embodiments, the base portion may circumscribe the tacky portion, as can be seen in FIG. 1, or may be located adjacent to the tacky portion, as can be seen in FIG. 14.

As can also be seen in at least FIG. 1, the floor mat has a base portion that has a continuous non-tacky exposed top surface area 250 for contacting the soles of a person's shoes thereon and a tacky portion having a tacky exposed top surface area 350 for contacting the soles of the shoes thereon. As can be seen also in FIGS. 15 and 16, the non-tacky exposed top surface area of the base portion and the tacky exposed top surface area of the tacky portion are both of a size such that an entire sole of an adult-sized shoe is receivable thereon. The continuous non-tacky exposed top surface area 250 of the base portion has a first side area 252 disposed on a first side 352 of the tacky exposed top surface area of the tacky portion and a second side area 254 disposed on a second, opposing side 354 of the tacky exposed top surface area of the tacky portion. The first side area of the continuous non-tacky exposed top surface area of the base portion is larger than the second side area of the continuous non-tacky exposed top surface area of the base portion.

In the following discussion, it is to be understood that the floor mat “base portion,” referred to in the foregoing primarily by the reference number 200, but also referred to in alternative embodiments by reference number 1820, for example, comprises at least a base portion underlayer and a non-tacky layer. At least a section of the non-tacky layer may be separable from the base portion underlayer. It should be understood that the base portion could be a single layer or multiple layers so long as it cooperates properly with the tacky insert.

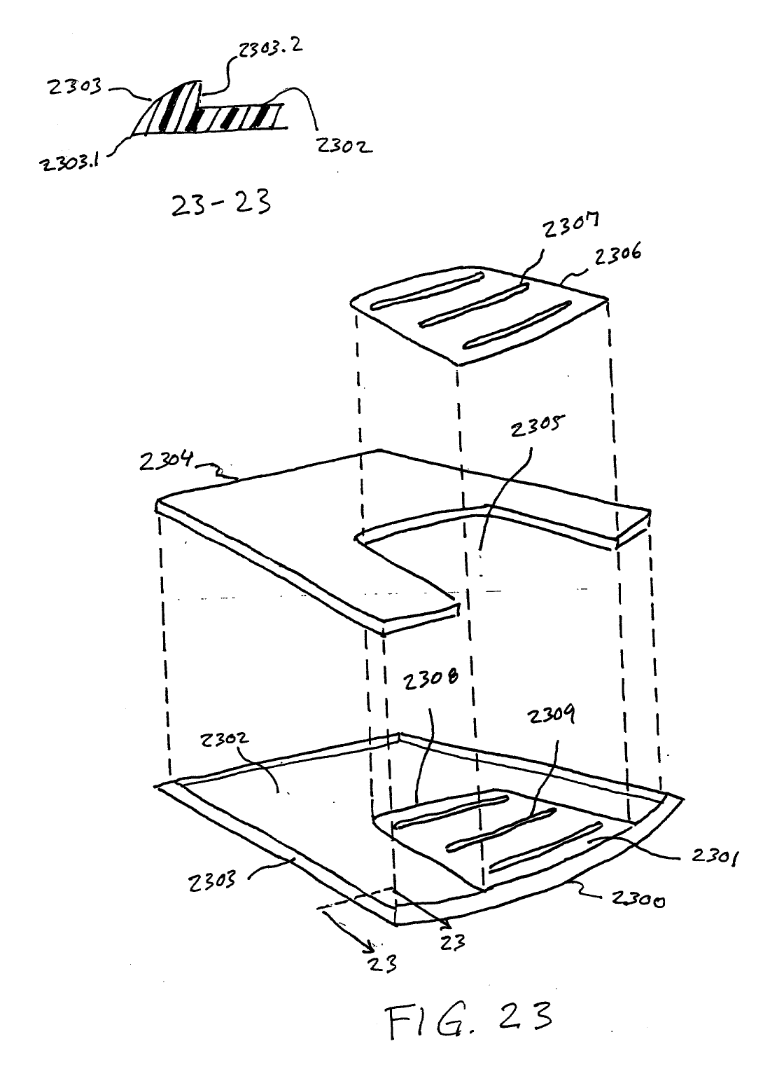

In consideration of the above, FIG. 23 is an exploded view of a floor mat according to yet another embodiment of the present invention. The floor mat includes a base portion underlayer 2300 formed as a substantially planar sheet of material of a pre-determined thickness and having a raised border 2303 circumscribing the planar sheet. The sheet of material includes a substantially planar surface 2302. The material may be a pliable, durable, water-resistant material such as vinyl, plastic or rubber, formed into the desired configuration by, for example, compression molding, injection molding, thermoforming, or other processes.

The base portion underlayer includes an area 2301 configured to receive a tacky insert 2306. The area 2301 may be bordered by a rim 2308 of material higher than the surface 2302. When placed within the area, the tacky insert may abut a section of the raised border 2303, so that the rim and the border cooperate in retaining the tacky insert within the base portion underlayer. The base portion underlayer includes anti-slip components 2309 in the area 2301. The anti-slip components extend through apertures 2307 in the tacky insert and also help to secure it in place on the base portion underlayer.

Further shown in FIG. 23 is a non-tacky layer 2304 of a pre-determined thickness configured to be received into base portion underlayer 2300 within the raised border 2303. A portion of the non-tacky layer may be permanently bonded to the base portion underlayer. The raised border 2303 may be formed as a “cove molding,” wherein, as shown in cross-sectional view 23-23, beginning at an outer edge 2303.1, the material of the border slopes upwardly and inwardly. An inner edge 2303.2, i.e., a difference in height between the planar surface 2302 and a part of the raised border may be substantially equal to a thickness of the non-tacky layer 2304. The non-tacky layer has a cut-out area 2305 that conforms to the shape of the tacky insert, so that when the non-tacky layer and the base portion underlayer are put together, edges of the cut-out area abut or are adjacent to the rim 2308, and the upper surface of the non-tacky layer is higher than the surface of the area 2301 for receiving the tacky insert. Thus, the base portion underlayer together with the non-tacky layer form a base portion having a recess configured to receive the tacky insert.

The non-tacky layer 2304 may have properties of components of the base portion 200 described earlier. For example, the non-tacky layer 2304 may have any combination of water-absorbing properties, water-dissipating properties, water-wicking properties, cushioning properties, antibacterial properties, antifungal properties, a fragrance, graphics and the like as described above in connection with base portion 200. The non-tacky layer may, for example, be a carpet. The area of a top surface of the non-tacky layer may be at least as large as the area of a top surface of the tacky insert. The areas of the top surfaces of the non-tacky layer and the tacky insert may be respectively of a size such that an entire sole of an adult-sized shoe is receivable thereon.

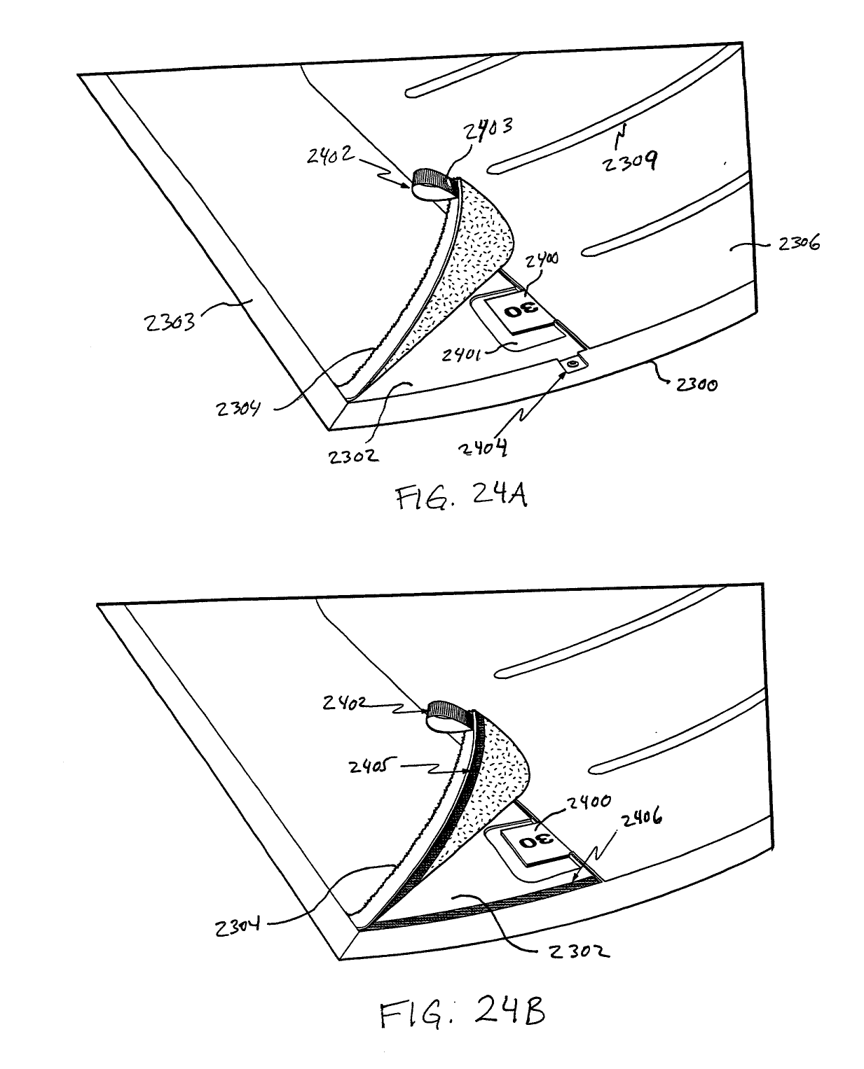

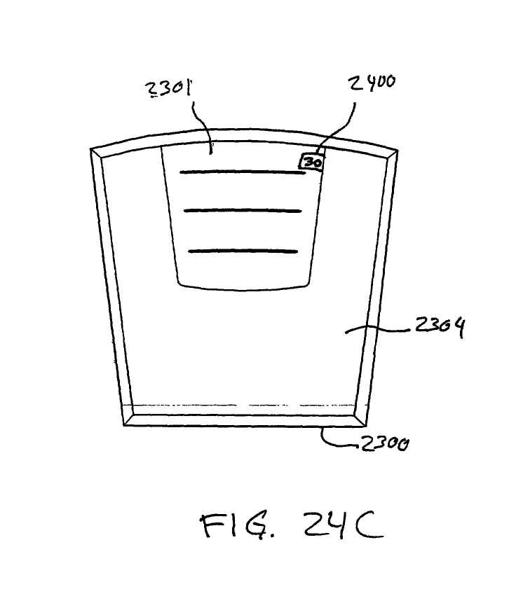

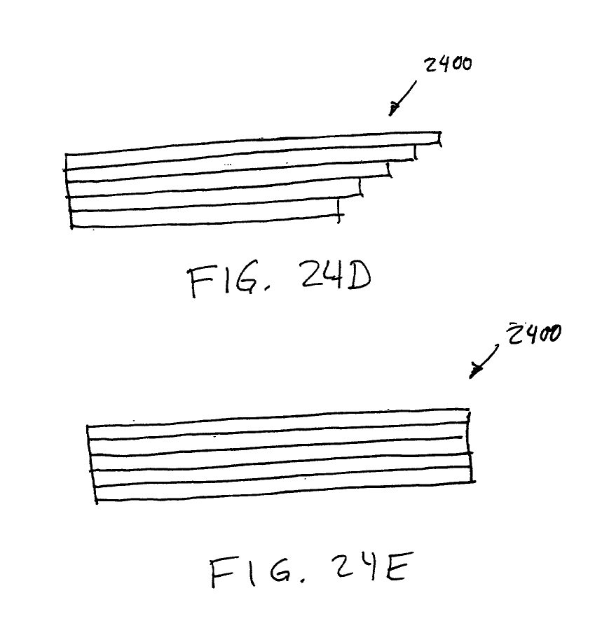

As discussed above, the tacky insert 2306 may comprise a plurality of separable layers. The layers may comprise a pliable, flexible material such as a polyethylene, bi-axially oriented polypropylene or polyester film coated with a pressure-sensitive adhesive to provide tackiness. A user of the floor mat may discard an insert layer which has become too soiled to effectively clean shoes, to expose a fresh layer underneath. To facilitate removal of a soiled layer, at least a section of the non-tacky layer 2304 may be separable from the base portion to expose a remove tab 2400 of a layer of the tacky insert, as shown in FIG. 24A. The remove tab 2400 facilitates easy removal of a layer of the tacky insert by enabling a user to grasp the remove tab and thereby apply a separating force to the layer. The remove tab 2400 could be formed of the same material as the tacky insert during a die-cutting process discussed in greater detail below, but without any adhesive, to enable easy handling. The remove tab could alternatively be formed from a different material and fastened to the tacky insert. A recess 2401 may be formed in the base portion underlayer to accommodate the remove tab or tabs.

A pull tab 2402, for example in the form of a loop of fabric, may be provided on an edge of the non-tacky layer to enable a user to separate a section of the non-tacky layer from the base portion underlayer. The separable section of the non-tacky layer could be secured to the base portion underlayer by readily-separable fasteners, for example, snap fasteners as shown in FIG. 24A, when in normal use. In FIG. 24A, the pull tab 2402 includes a receptacle component 2403 of the snap fastener, while the base portion underlayer includes a mated male component 2404. While the floor mat is in normal use, the non-tacky layer would lie flat on the base portion underlayer 2300, bringing the two snap fastener components into locking engagement, securing the separable section of the non-tacky layer to the base portion underlayer and concealing the remove tab or tabs 2400 to give the floor mat a more aesthetically pleasing appearance.

In an alternative embodiment as shown in FIG. 24B, the fasteners could be hook-and-loop fasteners such as VELCRO® and the like. In FIG. 24B, a VELCRO® strip 2405 is shown attached to an underside of the non-tacky layer 2304, and a mating VELCRO® strip 2406 is shown attached to the planar surface 2302 of the base portion underlayer 2300. While the floor mat is in normal use, the non-tacky layer would lie flat on the base portion underlayer 2300, bringing the two VELCRO® strips into contact, securing the separable section of the non-tacky layer to the base portion underlayer and concealing the remove tab or tabs 2400.

Alternatively to the remove tab 2400 extending into the area of the base portion underlayer covered by the non-tacky layer so that the remove tab is hidden, the remove tab could extend into the area 2301 of the tacky insert, as shown in FIG. 24C. The tabs could be numbered, to indicate to a user, for example, how many tacky insert layers have been used.

FIGS. 24D and 24E show side elevation views of remove tabs 2400 corresponding to the case when the tacky insert comprises a plurality of layers. As shown in FIG. 24D, the remove tabs could be layered in a graduated fashion, such that an edge of an upper tab extends beyond an edge of a tab below it. Such an arrangement could enable easier manipulation of a remove tab. Alternatively, the tabs could be co-extensive as shown in FIG. 24E.

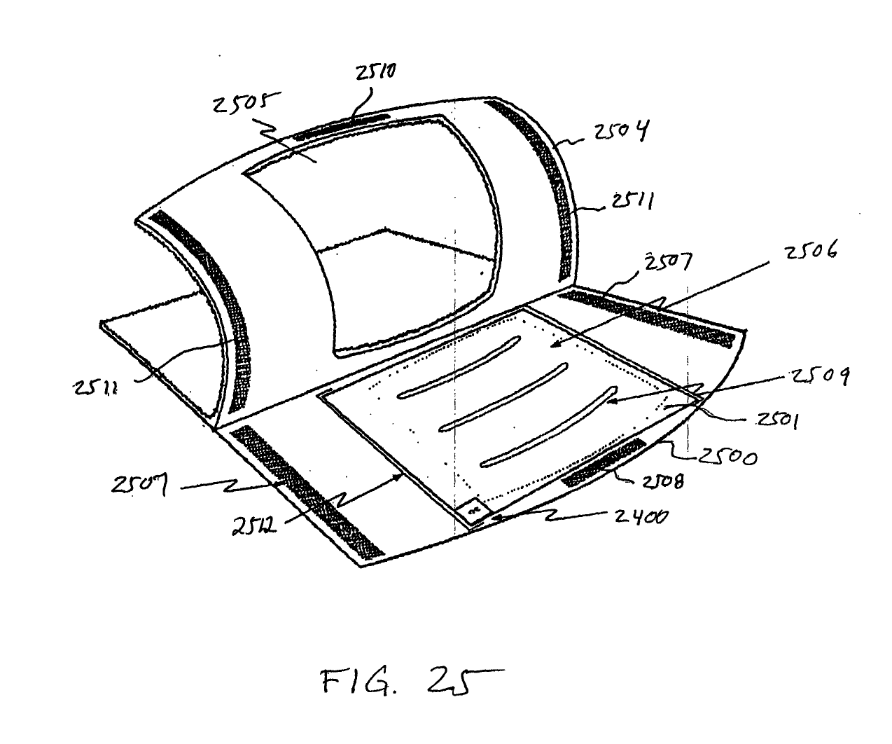

FIG. 25 shows an embodiment of the floor mat wherein a base portion underlayer 2500 is joined to a non-tacky layer 2504 and is substantially co-extensive with the non-tacky layer. That is, in the embodiment of FIG. 25, the base portion underlayer does not have a raised border as in the embodiment of FIG. 23. Rather, edges of the base portion underlayer 2500 and the non-tacky layer 2504 are substantially in alignment. The base portion underlayer has an area 2501 configured to receive a tacky insert.

At least a section of the non-tacky layer 2504 is separable from the base portion underlayer, as shown in FIG. 25. The non-tacky layer includes fasteners 2510, 2511 on an underside thereof, for connecting to fasteners 2507 and 2508, respectively, on the base portion underlayer. The fasteners could be readily-separable fasteners such as VELCRO ® strips. The separable section of the non-tacky layer 2504 has a cut-out area 2505 with edges configured to frame a top surface area of a tacky insert 2506. The cut-out area 2505 is sized to be smaller than the top surface area of the tacky insert, so that when the separable section of the non-tacky layer is laid flush with the base portion underlayer, edges of the tacky insert placed into the base portion underlayer extend beyond edges of the cut-out area. The area of the tacky insert framed by edges of the cut-out area 2505 may be of a size such that an entire sole of an adult-sized shoe is receivable thereon. Thus, the cut-out area provides access to the tacky insert for cleaning shoes, while also helping to secure the tacky insert within the base portion underlayer. Separating the non-tacky layer from the base portion underlayer would enable easier insertion of the tacky insert. Alignment marks 2512 bordering area 2501 help a user to position a tacky insert correctly on the base portion underlayer so that apertures in the tacky insert engage the anti-slip components 2509. The tacky insert could have a uniform shape, such as a rectangular shape for easy manufacture and storage, while the cutout area could have any desired shape, allowing a user to select a shape of the exposed portion of the tacky insert which is aesthetically pleasing to him or her. The shape could be a keystone shape, for example.

The areas 2301 or 2501 (of the embodiments of FIGS. 23 and 25, respectively) of the base portion underlayers configured to receive the tacky insert could be provided with a “background” layer having a pattern or color grain designed to be aesthetically coordinated with the non-tacky insert. For example, if the non-tacky layer was a carpet of some selected color and/or pattern, the background layer could be selected to match the color and pattern of the carpet. The background layer could be permanently bonded to the base portion underlayer, and in such a case the tacky insert would be transparent to show the background layer.

Alternatively, some or all or the layers of the tacky insert could have a pattern and/or color grain. These could be used instead of a permanent background layer, or could be used to temporarily cover a permanent background layer. Or, the base layer of a plurality of layers of the tacky insert could have a pattern or color grain, and the rest of the layers would be transparent to show the base layer. The pattern and/or color grain of a layer or layers of a tacky insert could be customized as desired, for example, to reflect a particular holiday season.

If the tacky insert comprises a plurality of layers, a base layer could have an adhesive undersurface to secure the layers to the base portion underlayer. The tacky insert could also have such an adhesive undersurface if it consisted only of a single layer. In either case, the undersurface adhesive would be strong enough to ensure that the insert was not easily dislodged from the floor mat when used to clean shoes, but not so strong that the insert would be difficult to remove by deliberate manipulation and application of force for that purpose.

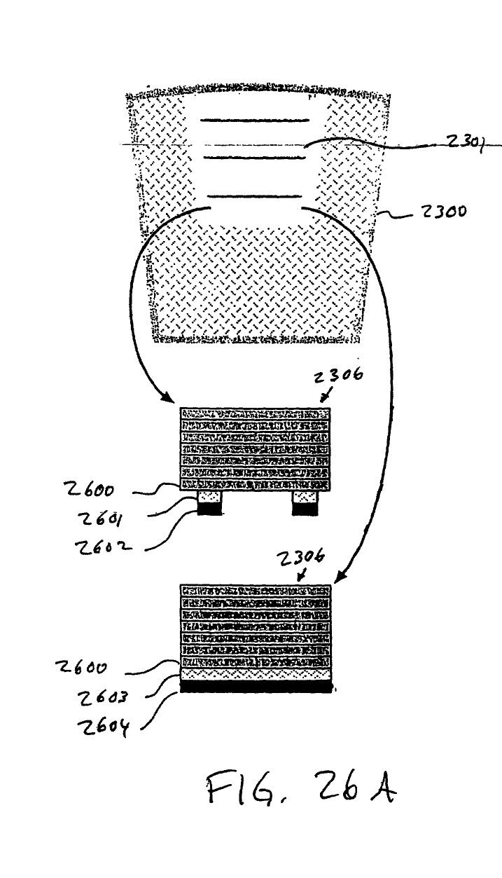

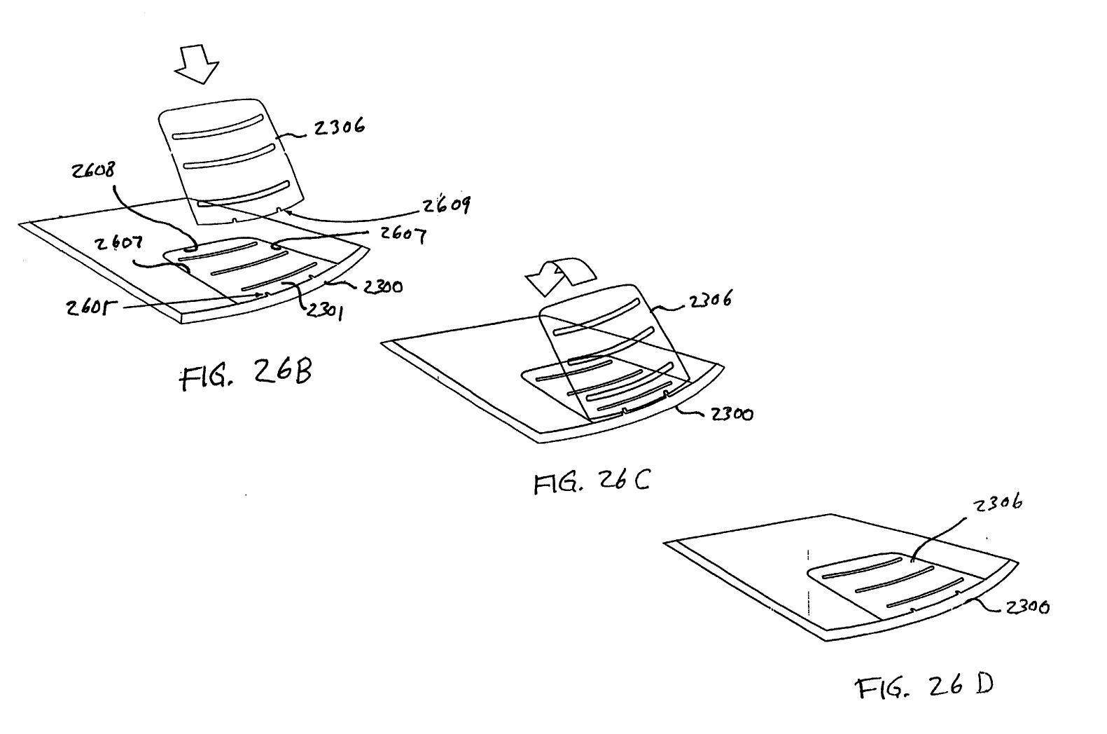

Similarly, whether in the form of a single layer or a plurality of layers, the tacky insert may further be provided with a release layer, as shown in FIG. 26A. FIG. 26A shows side elevation views of two possible embodiments of a tacky insert 2306 comprising a plurality of layers (the dimensions of the layers are exaggerated for purposes of illustration). The embodiments have a base layer 2600 with two different types of adhesive undersurface with a release layer. In one embodiment, the adhesive undersurface comprises at least two strips of adhesive 2601, each with a release layer 2602. At least a portion of the undersurface of the base layer bearing the strips is not adhesive. In the other embodiment, the adhesive undersurface 2603 and its release layer 2604 are co-extensive with the base layer.

The release layer functions along lines similar to that of a peel-off sticker, Band-Aid® or the like. The release layer covers the adhesive undersurface of the tacky insert. The release layer has a non-adhesive outer surface for easy handling, and an inner surface for contacting the tacky insert undersurface. The inner surface of the release layer is easily separable from the tacky insert undersurface when a user wants to install the tacky insert in the base portion.

FIGS. 26B-26D illustrate one possible embodiment of the invention for simplifying the placing of a tacky insert with an adhesive undersurface and a release layer into the base portion. As shown in FIG. 26B, the base portion underlayer 2300 is provided with alignment protrusions 2605 on a section of the raised border extending along the area 2301 for receiving the tacky insert. The location of the alignment protrusions is arbitrary and could depend on the shape of the tacky insert. The alignment protrusions could alternatively be located, for example, on sides 2607 or an end 2608 of the area 2301.

A tacky insert 2306 is provided with notches 2609 spaced so as to correspond to protrusions 2605. As shown in FIG. 26C, a user may peel off the release layer (not shown), then bring the notches of the tacky insert into engagement with the protrusions of the base portion underlayer to align and stabilize the tacky insert in preparation for lowering the tacky insert to bring it into engagement with the base portion underlayer. Then, perhaps applying the tacky insert in a “rolling” motion, the user brings the undersurface of the tacky insert into contact with the base portion underlayer as shown in FIG. 26D, possibly applying pressure to ensure adequate adhesion.

According to another embodiment not illustrated, the release layer could be separated into two or more sections. Apertures aligned with the apertures of the tacky insert would also be formed in the release layer. To install a tacky insert with such a release layer, a user could align the apertures with the anti-slip components and place the tacky insert into the base portion underlayer with the release layer still on. Then, because the tacky insert is flexible, the user could lift and bend a portion of the tacky insert away from the base portion underlayer. While holding the remaining portion in place, the user could remove a section of the release layer from the lifted portion of the tacky insert, lower the uncovered portion to the base portion underlayer, and apply pressure to adhere the uncovered portion to the base portion underlayer. Then, the user could lift and bend the remaining, un-adhered portion of the tacky insert, remove the release layer, and adhere the remaining portion of the tacky insert to the base portion underlayer.

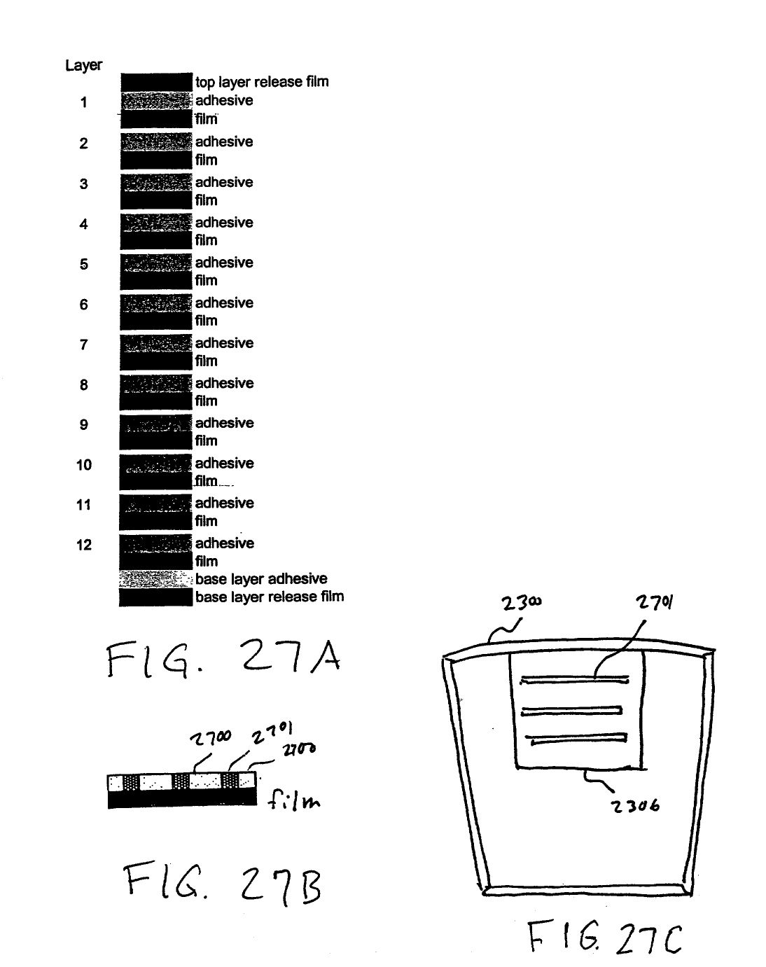

As noted above, a tacky insert could comprise a plurality of separable layers. FIG. 27A is a side elevation view illustrating one possible sequence of layers in a tacky insert. In the example of FIG. 27A, the tacky insert has 12 layers, but clearly a tacky insert having more or fewer layers is readily contemplated. In FIG. 27A, each of layers 1-12 comprises at least an adhesive layer and a film layer. The adhesive layer provides the tacky surface of the tacky insert for cleaning shoes as described above, when exposed for use. The film is a medium for the adhesive layer.

In addition to adhesive and film layers, the top layer 1 and base layer 12 each include a release layer. The release layers have a non-tacky outer surface (i.e., the surfaces opposite the surfaces in contact with an adhesive layer) to enable a group of layers to be easily packaged, unpackaged and handled by a user. The release layers are easily separated from the adhesive layer when a user needs to install a tacky insert into a base portion of a floor mat.

To install a multi-layer tacky insert as shown in FIG. 27A, a user would peel away the base release layer from layer 12 to expose the base layer adhesive, then install the tacky insert in the base portion of the floor mat. The tacky insert could have notches, or a base release layer of two sections, to facilitate installation of the tacky insert into the base portion as described above. The base layer adhesive would secure the tacky insert within the base portion. The film of the base layer 12 or other layers could have a background pattern or color grain as described above.

The user would then remove the top release layer to expose the adhesive surface of the first layer for use. After the first layer became soiled by use, the user would remove the first layer to expose the adhesive surface of the second layer, and begin using the second layer. The bond between the adhesive surface of one layer and the film of the layer above it would be strong enough to ensure that the upper layer was not easily dislodged from the lower layer or layers when used to clean shoes, but not so strong that the upper layer would be difficult to remove by deliberate manipulation and application of force for that purpose. When all the layers of the insert were used up, the user could remove the base layer and install a new insert.

FIG. 27B illustrates an alternative embodiment of a layer of a tacky insert. As shown in FIG. 27B, a layer of a tacky insert could comprise adhesive 2700 interspersed with an integral anti-slip material 2701, overlaid on a film layer. The anti-slip material could extend in a strip across the layer, as shown in FIG. 27C. This integral anti-slip material could be used to perform an anti-slip function in substitution for anti-slip components of the base mat underlayer which are received by apertures in the tacky insert. Alternatively, both integral anti-slip material and anti-slip components received in apertures of the tacky insert could be used to provide an anti-slip function.

A method and apparatus for manufacturing a tacky insert comprising a plurality of layers will now be described. A basic material for forming the layers could be a low-density polyethylene, bi-axially oriented polypropylene or polyester film manufactured and distributed in bulk quantities in units of continuous rolls. The basic material could also be provided in the form of individual sheets. Typically, film is fed from the rolls and sent through a series of mechanized and automated layering processes involving the application of adhesive to provide a tacky surface, the application of release layers to facilitate packaging and handling, and the cutting of layers into the desired shape.

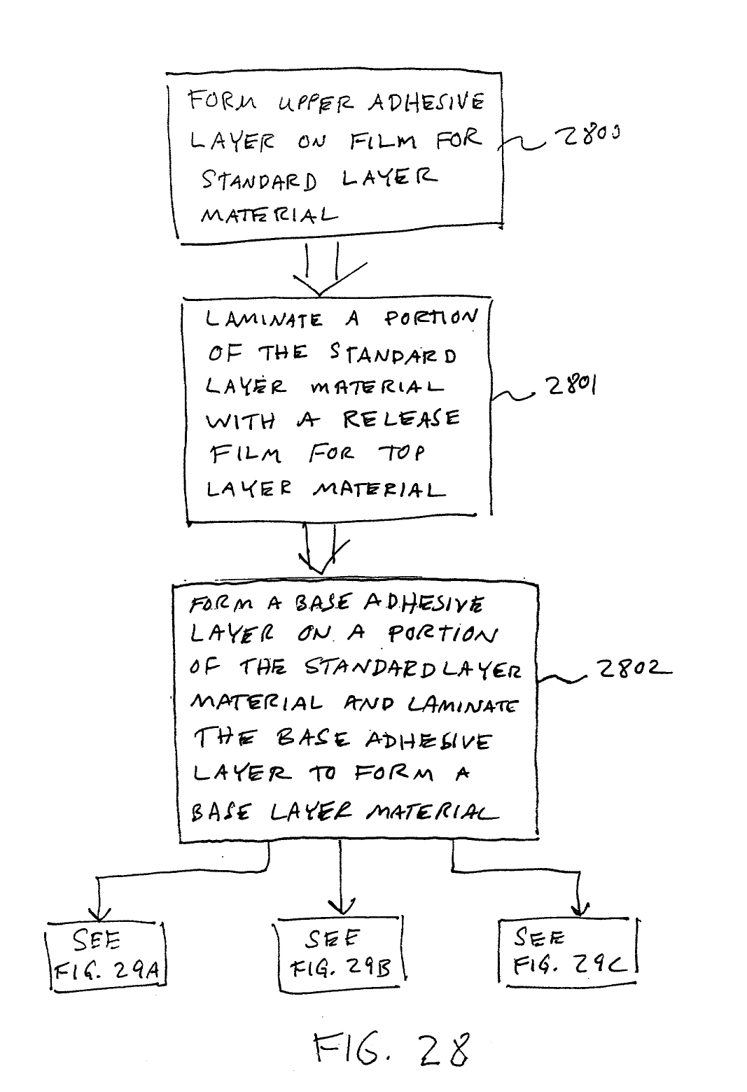

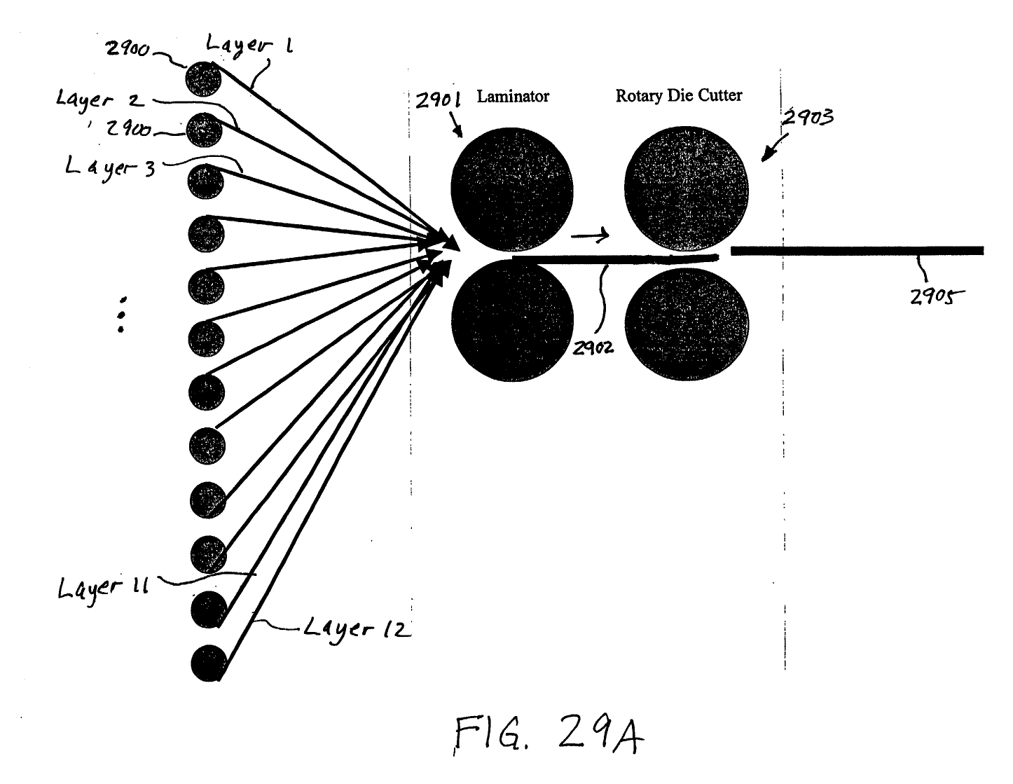

Referring now to FIG. 28, the process for forming tacky inserts includes forming an upper adhesive layer on a film, as shown in block 2800. The upper adhesive layer can be formed by known processes, for example, using a reverse roll coater machine or a gravure coater machine in a roll-to-roll process. The film with an upper adhesive layer constitutes a standard layer material for layers of the tacky insert, which is included in all layers subsequently formed. Then, using a laminator, a portion of the standard layer material is laminated with a top layer release film to form a top layer material for forming a top layer of an insert, as shown in block 2801. This top layer corresponds to layer 1 as shown in FIG. 27A.

A base layer material for forming a base layer of an insert is formed from a portion of the standard layer material by using a reverse roll coater or gravure coater, for example, to add a base adhesive layer to the side of the film opposite the side with the upper adhesive, and using a laminator to laminate the base adhesive layer with a base layer release film, as shown in block 2802. This base layer corresponds to layer 12 as shown in FIG. 27A.

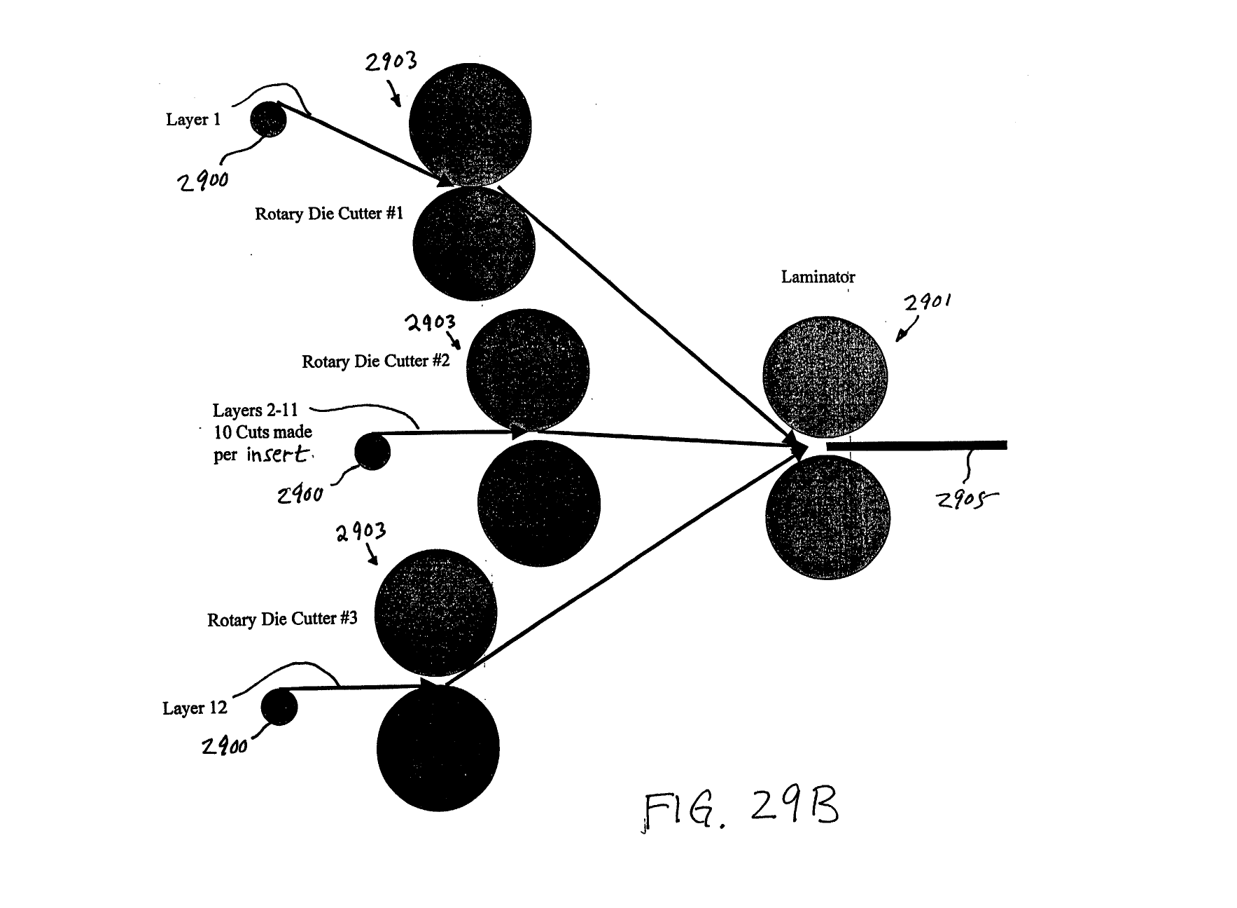

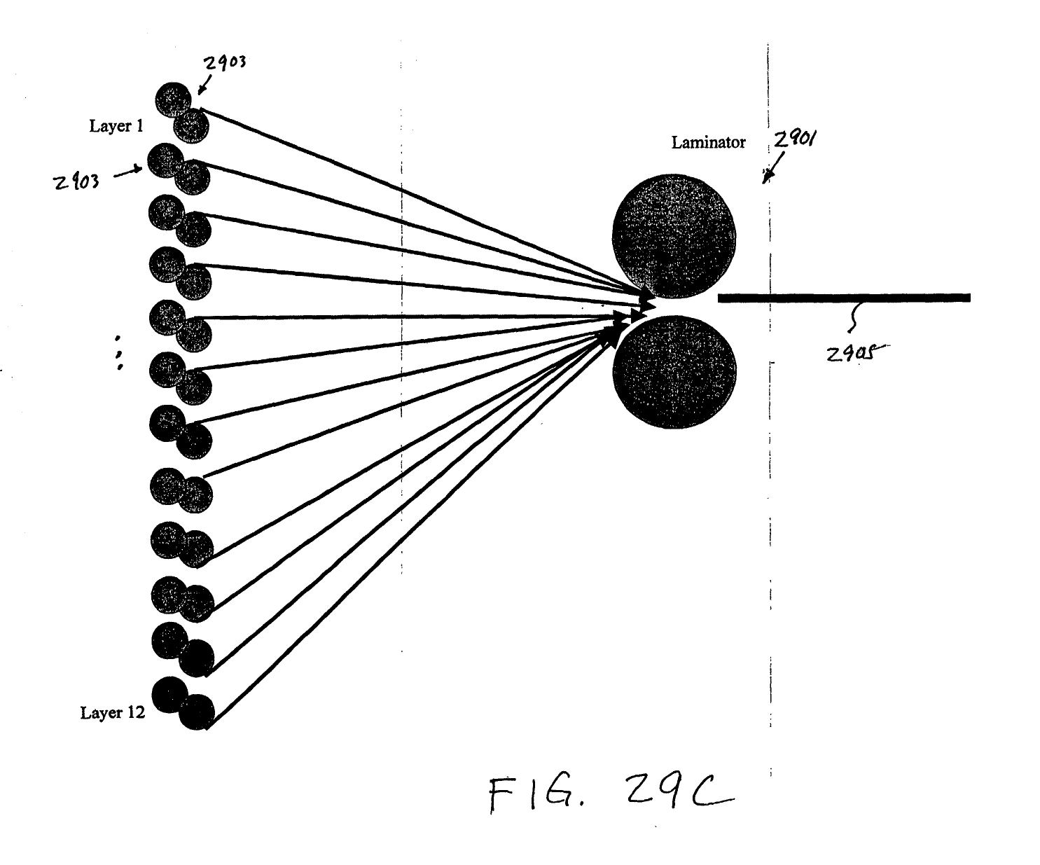

The constituent standard layer, top layer and base layer materials of the tacky insert are then subjected to further processing by alternative methods according to the invention to produce tacky inserts, as illustrated in FIGS. 29A, 29B and 29C, respectively, and discussed in greater detail below.

According to a known method called “multiple lay-up” (not illustrated), all the layers may first be brought together into multi-layered laminate which is subsequently cut into tacky insert shapes. However, this process suffers from the disadvantage that undesirable bonding of the cut layers can occur at the edges thereof.

Thus, to avoid the problem of edge bonding, the tacky inserts may be formed in a process involving a rotary die cutter according to at least three alternative embodiments of the invention. Rotary die cutters are well-known in the manufacturing arts. However, the use of rotary die cutters in a process to form a multi-layered structure as shown in FIG. 27A is not known.

FIG. 29A shows an apparatus configured to cut tacky inserts using a rotary die cutter according to the invention. A number (for example, 12) of individual rollers 2900 are shown for feeding the top layer, standard layer, and base layer materials, respectively, to a laminator 2901 and then to a rotary die cutter 2903. The layers are fed in a continuous form known as a “web.” A laminator is a known machine which is configurable to apply a pre-determined amount of pressure and tension via rollers to a plurality of webs so as to join webs to each other with a desired bonding strength. For example, the laminator would apply sufficient pressure such that, once finished, a tacky insert would not easily separate into its constituent layers upon casual handling, but not so much pressure that layers would effectively fuse together and be difficult to separate by deliberate manipulation and application of force for that purpose.

After the layers are joined by the laminator to form a 12-layer web 2902, they are processed by the rotary die cutter 2903. The rotary die cutter 2903 cuts a 12-layer tacky insert 2905 of a desired shape from the web 2902.

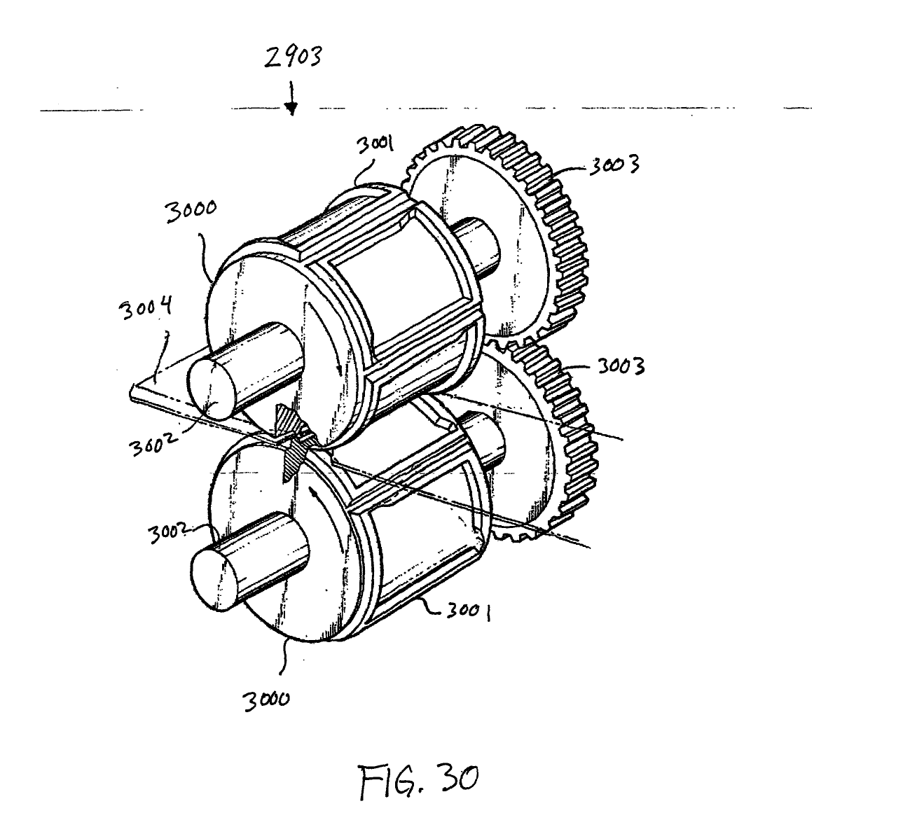

A more detailed example of a rotary die cutter is shown in FIG. 30. A rotary die cutter typically comprises at least two substantially cylindrical drums 3000 juxtaposed and rotating in opposite directions to each other. The drums rotate on shafts 3002 driven by gears 3003. Outer surfaces of the drums include engraved knives 3001 outlining a desired shape to be cut out of a web 3004. A shape on one of the drum surfaces is the mirror image of the shape on the opposing drum surface. In the case of tacky inserts, the outlined shape could be a keystone shape, for example, as described above. The drums are aligned and their speed of rotation is set so that corresponding knives on the respective drums come into contact during rotation, cutting the desired shape out of the web material. Alternatively, the engraved knives could be on only one drum, while the opposing drum had a smooth surface. Typically, a stripping device (not shown) is used to separate the cut-out web material from the drums.

FIG. 29B shows an alternative configuration utilizing a rotary die cutter. In FIG. 29B, the tacky insert shapes are first cut out of the basic materials for the respective layers, then joined by a laminator to produce the tacky insert. Top layer material is fed to a top layer rotary die cutter, rotary die cutter #1, which is used to cut out an insert shape for the top layer. Standard layer material is fed to a second, single standard layer rotary die cutter, rotary die cutter #2, which is used to cut out insert shapes for the standard layers. In the present example, 10 standard layer insert shapes are successively cut out by rotary die cutter #2 and stacked in an intermediate stacker (not shown) prior to being laminated together with the top and base layer insert shapes. Base layer material is fed to a base layer rotary die cutter, rotary die cutter #3, which is used to cut out an insert shape for the base layer. Then the top layer, standard layers and base layer insert shapes are laminated together by laminator 2901 to produce a tacky insert 2905.

FIG. 29C illustrates a configuration wherein the insert shapes are cut out of their respective materials before being laminated together, but wherein each layer of the tacky insert is cut to shape by an individual rotary die cutter.

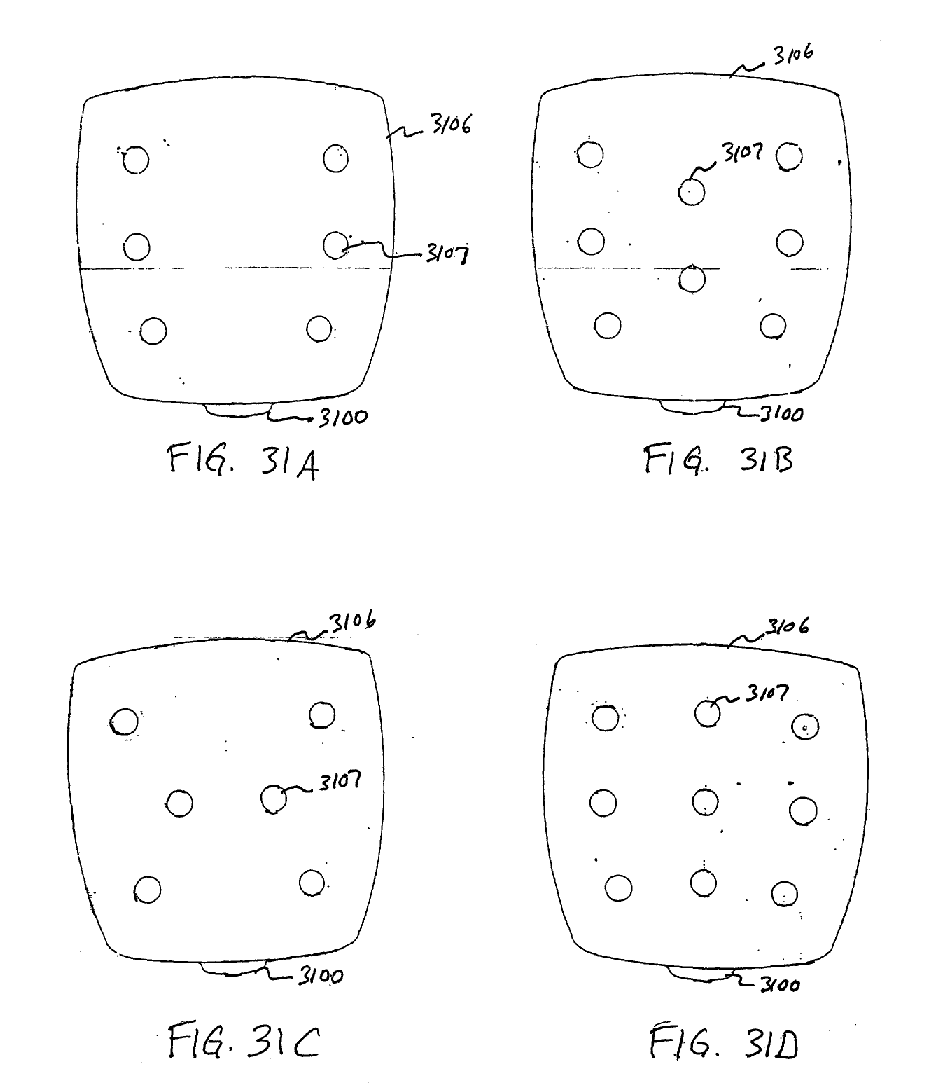

FIGS. 31A-31D show plan views of additional embodiments of a tacky insert 3100 such as could be formed by the above-described process. FIGS. 31A-31D show a different kind of aperture in the tacky insert for receiving anti-slip components of the base portion underlayer. Whereas, in the embodiments of earlier-discussed figures, the apertures are relatively elongated in order to receive elongated, “rib-like” anti-slip components, in FIGS. 31A-31D, apertures 3107 have a substantially circular form, for receiving nodular, “bump-like” anti-slip components. The apertures 3107 could have various arbitrary distributions, as shown in the figures. Also, the aperture shapes are not limited to circular shapes but could have arbitrary shapes, such as oval, square, rectangular or triangular shapes.

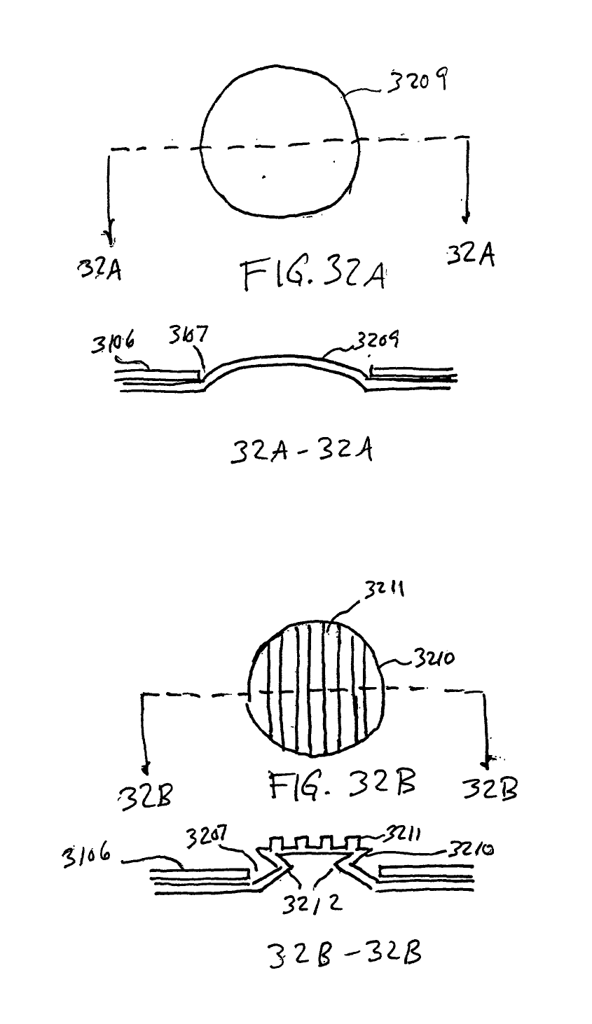

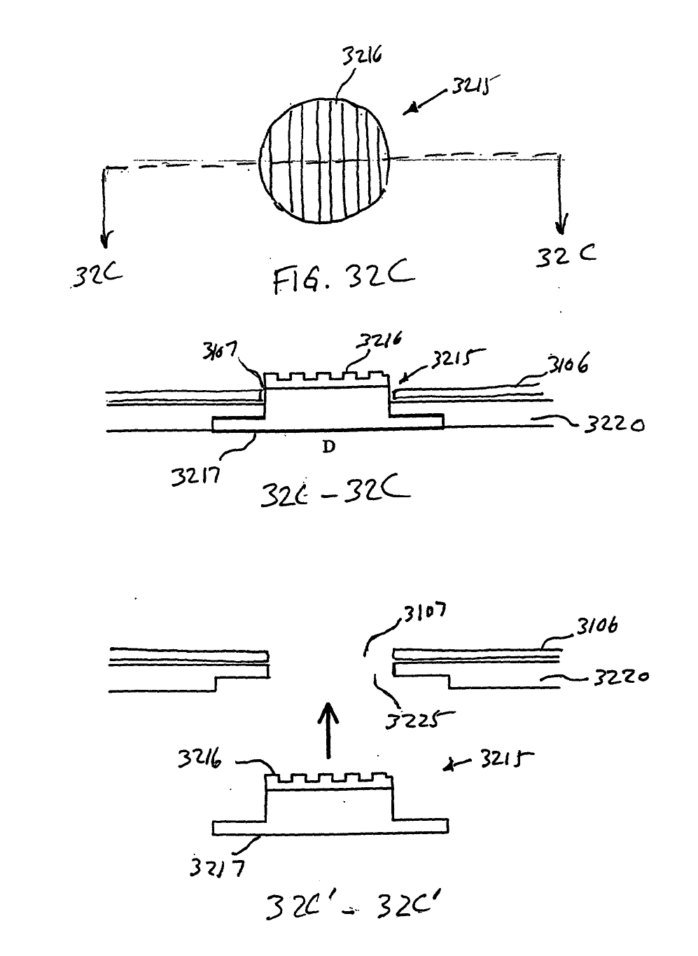

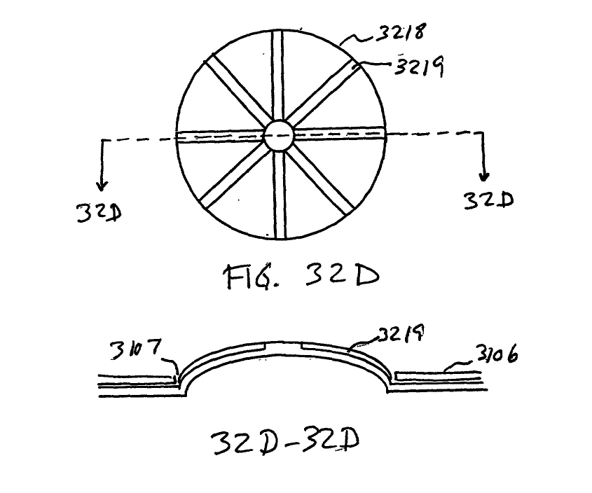

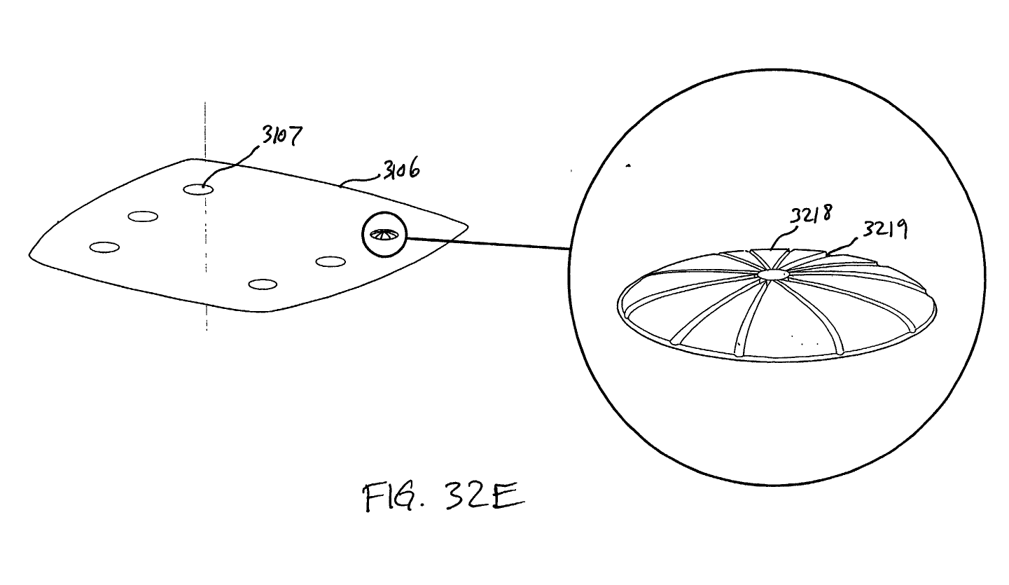

FIG. 32A shows a plan view of a nodular anti-slip component 3209 of the base portion underlayer. Cross-sectional view 32A-32A shows the anti-slip component 3209 received within a circular aperture 3107 of a tacky insert 3106. An upper surface of the anti-slip component extends beyond an upper surface of the tacky insert. The anti-slip component 3209 is deformable such that it will be deformed downwardly when the pressure of a person's shoe is applied to the anti-slip component, allowing the sole of the shoe to come into contact with the tacky surface of the insert. When the pressure of the shoe is removed, the anti-slip component resumes its original form.

FIG. 32B shows a plan view of an embodiment of a nodular anti-slip component 3210 having textural features 3211 on an upper surface thereof, for better slip prevention. Cross-sectional view 32B-32B shows the anti-slip component 3210 received within a circular aperture 3107 of a tacky insert 3106. The anti-slip component is deformable and has a spring-like form wherein pressure applied by a shoe causes the anti-slip component 3210 to be compressed at pre-determined bend points 3212, allowing the sole of a shoe to come in contact with the tacky surface of the insert. When pressure is removed, the anti-slip component 3210 springs back to its original shape.

FIG. 32C shows a plan view of yet another embodiment of a nodular anti-slip component 3215 which includes textural features 3216 on an upper surface thereof. Cross-sectional view 32C-32C shows the anti-slip component 3215 received within a circular aperture 3107 of a tacky insert 3106. The textural features 3216 are arranged on a support portion 3217 of the anti-slip component. The textural features may be made of a relatively non-deformable material, such as a hard rubber or plastic, while the support portion 3217 may be made of a deformable material such as foam rubber, to allow contact with the tacky surface as described above.

As shown in exploded view 32C′-32C′, the anti-slip component 3215 may be separable from the base portion underlayer 3220, to allow the anti-slip component to be replaced when worn. On the other hand, the anti-slip component could be permanently bonded to the base portion underlayer. An aperture 3225 in the base portion underlayer may be countersunk, to allow for a flush meeting of the anti-slip component and a bottom surface of the base portion underlayer.

FIG. 32D shows a plan view of yet another embodiment of a deformable nodular anti-slip component 3218 which includes textural features embodied as grooves 3219 in an upper surface thereof. Cross-sectional view 32D-32D shows the anti-slip component 3218 received within a circular aperture 3107 of a tacky insert 3106. Breaking up the surface of the anti-slip component with grooves as shown aids compressibility and introduces a texture to the anti-slip component which further reduces slipping. FIG. 32E shows an enlarged perspective view of anti-slip component 3218.

Textural features 3211, 3216 and 3219 as discussed above are illustrated by way of example only. Any kind of textural feature which breaks up the surface of the nodular anti-slip component is encompassed within the scope of the inventive concept disclosed herein. Example of other kinds of textural features that could be used include bumps, ridges, dimples, raised spirals, automobile-tire-like patterns, random patterns and the like.

Returning to FIGS. 31A-31D, a remove tab 3100 is provided on an edge of the tacky insert. As with the remove tabs 2400 described above, the remove tabs 3100 could be formed of the same material as the tacky insert during a die-cutting process as discussed above, but without any adhesive, to enable easy handling. The remove tab could alternatively be formed from a different material and fastened to the tacky insert. The remove tab location is arbitrary. The base portion underlayer could have a recess for receiving the remove tab.

It has been observed that a tendency exists for substances, such as oils, solvents, uncured plastic or rubber to migrate from the material of the base portion underlayer to the undersurface adhesive of a tacky insert which is in contact with the base portion underlayer. These migrating substances may degrade the adhesive of the tacky insert undersurface, potentially causing the tacky insert to fail to adhere to the base portion underlayer in a satisfactory fashion. Moreover, independently from the migration phenomenon, it is desirable to ensure adequate adhesion of the tacky insert to the base portion underlayer when inserted therein.

Thus, according to embodiments of the invention, the area 2301 of the base portion underlayer configured to receive a tacky insert may have a layer of material thereon to provide the function of promoting adhesion of the tacky insert to the base portion underlayer. The adhesion promoting layer may be formulated or designed such that it has an affinity for an adhesive of the tacky insert. The adhesion promoting layer may additionally or alternatively promote adhesion by introducing a barrier which prevents or reduces the migration of unwanted substances from the base portion underlayer to the tacky insert.

An adhesion promoting layer according to embodiments of the invention may comprise, for example, any of the family of acrylics and urethanes, or any other suitable material. The adhesion promoting layer may be applied to the area 2301 by any of a number of known application methods, for example, by spraying or painting it on.

Alternatively, the adhesion promoting layer may be a mechanical member such as a thin, die-cut sheet of material. The member could be rigid or pliable. The material of the member could be, by way of example only, metal, or plastic such as HDPE (high density polyethylene), polyester resin, or LEXAN®. The member could be directly molded into the base portion underlayer.

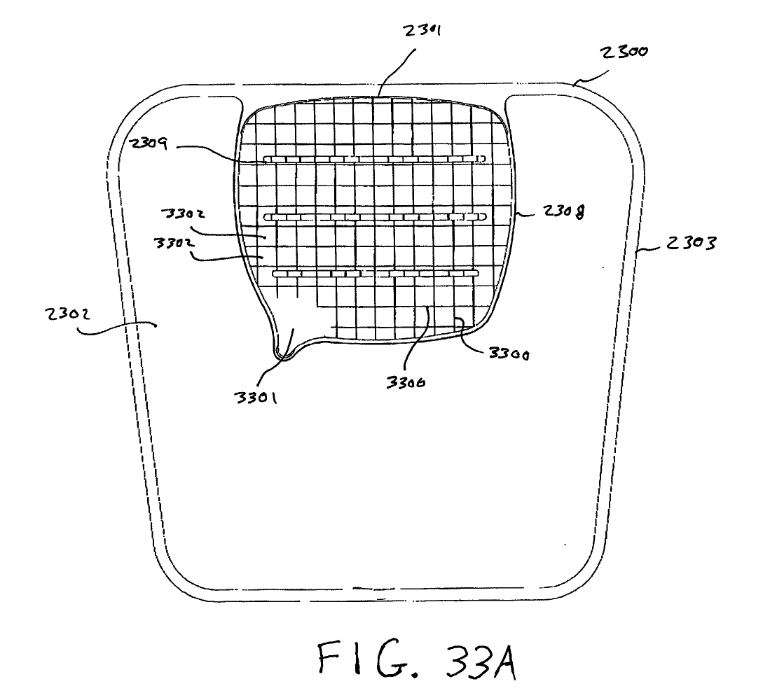

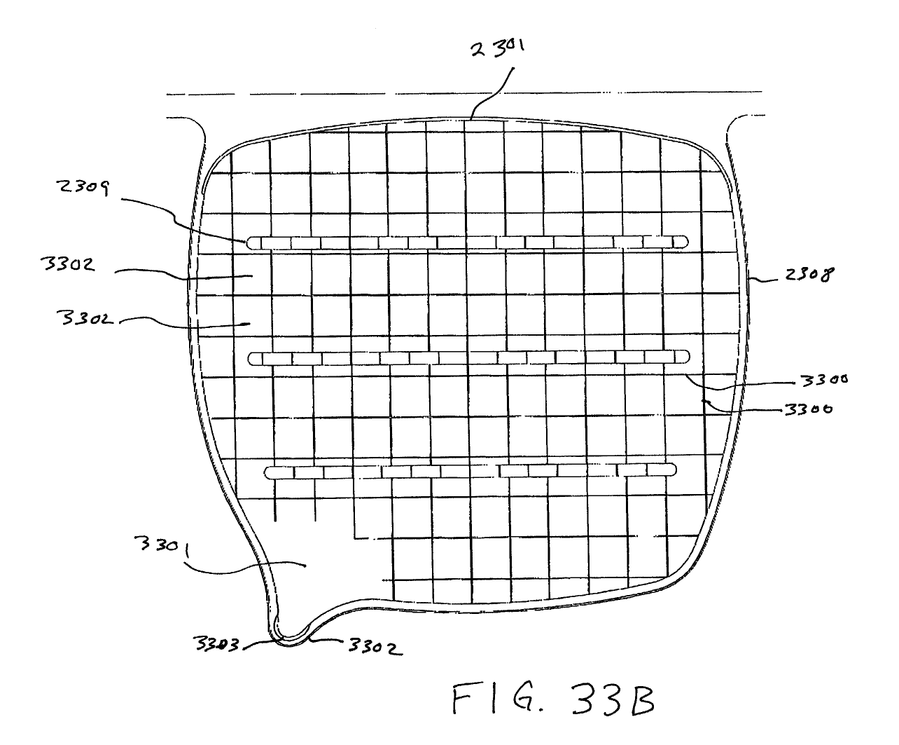

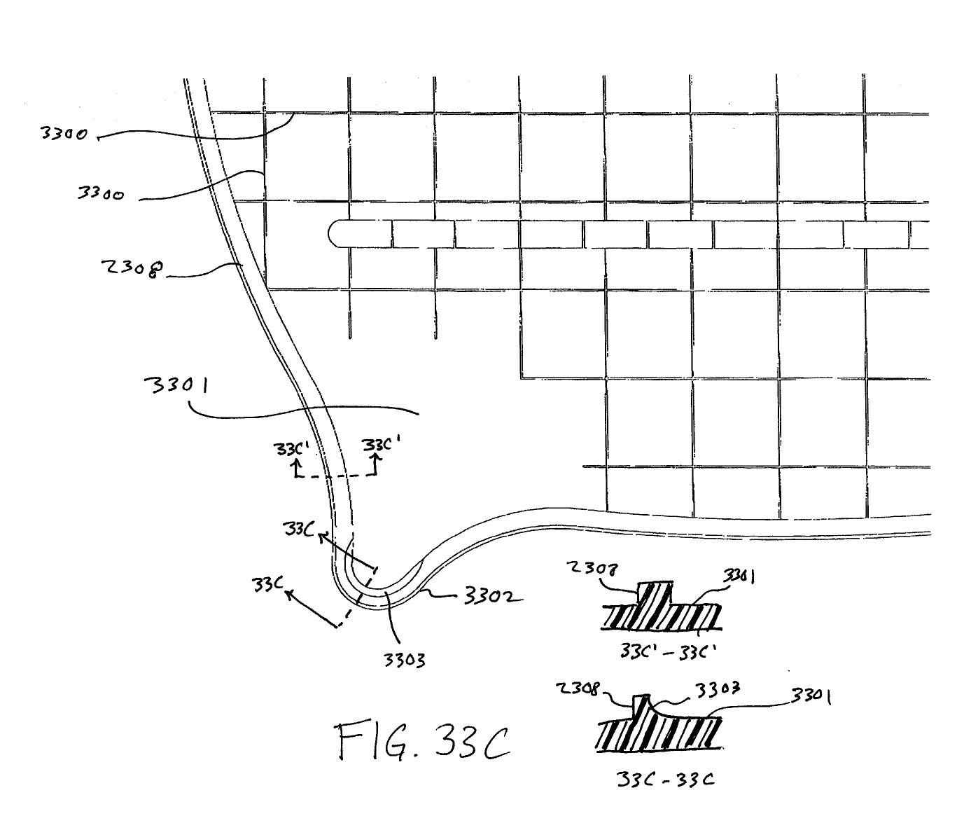

FIG. 33A shows yet another embodiment of a base portion underlayer 2300 according to the invention. In the embodiment shown in FIG. 33A, the area 2301 configured to receive a tacky insert may comprise channels 3300. The channels are formed as indentations or grooves in the material of the base portion underlayer. The channels could be formed integrally with the base portion underlayer by, for example, compression molding, injection molding, thermoforming, or other processes as described above.

The channels may be arranged so as to interconnect. A plurality of interconnecting channels may form a grid. The grid may, for example, define substantially rectangular sections 3302 as shown in FIG. 33A, but the invention is not limited to a grid of rectangular sections; other interconnected channel patterns of unspecified or random geometry are readily contemplated. When a tacky insert is placed into area 2301 as shown in FIG. 33A, the channels 3300 act to prevent or reduce the formation of air bubbles between the base portion underlayer and the undersurface of the tacky insert, by providing a pathway for air to escape from under the tacky insert when pressure is applied thereto. By channeling air away from under the tacky insert, the cosmetic appearance of the floor mat and the overall bond between the tacky insert and the base portion underlayer is improved.

An embodiment of the base portion underlayer which includes channels in the area 2301 configured to receive a tacky insert may further have an adhesion promoting layer as described above. If the adhesion promoting layer was, for example, an acrylic or polyurethane that was sprayed or painted on, the layer would conform readily to the channels. Also, if the adhesion promoting layer was a pliable mechanical member such as a thin sheet of polyethylene, the member could be pressed in so as to conform to the channels.

Alternatively, the mechanical member, whether pliable or rigid, could itself contain channels. The channels could pass through the thickness of the member such that they formed openings in the member. Such channels could be arranged so as to align with channels in the base portion underlayer. Or, the base portion underlayer could be without channels, and instead, only the mechanical member would have channels. The channels could pass through the thickness of the member, or instead only be indentations or grooves in an upper surface of the member.

Further illustrated in FIG. 33A is a channel-free portion 3301 within the rim 2308 bordering area 2301. The channel-free portion 3301 may be provided for better adhesion of the tacky insert adjacent a region where a remove tab of the tacky insert may be disposed, as described in greater detail below. While, as noted above, the air pathways established by the channels improve the appearance of the floor mat and the overall bond between the tacky insert and the base portion underlayer, the channels represent a trade-off between an air removal function and surface area for adhesion. In general, optimal adhesion is achieved by maximizing the contact area between the tacky insert and the base portion underlayer. The channels introduce a known, negligible loss of surface area while lowering the risk of large, randomly located areas of trapped air.

FIG. 33B shows an enlarged view of area 2301. The rim 2308 of area 2301 includes an extension 3302 defining a region for receiving a remove tab of a tacky insert. Adjacent the region for receiving the remove tab, the problem of air bubble formation is less likely to occur, due to the smaller amount of contact area between the adhesive of the tacky insert and the base portion underlayer. Moreover, the region for receiving the remove tab is located near an edge of the area 2301, making it easier to press out an air bubble should one form in this region. Therefore, it is advantageous to maximize contact surface area in the region for receiving the remove tab by not forming a channel therein.

As discussed above, a remove tab of a tacky insert could be formed of the same material as the tacky insert, but be free of adhesive to enable easy handling. The extension 3302 includes a chamfered portion 3303 to enable easy manipulation of a remove tab disposed within extension 3302.

FIG. 33C shows an enlarged view of channel-free portion 3301, extension 3302 and chamfered portion 3303. View 33C′-33C′ shows a cross section of rim 2308 where there is no chamfering, and view 33C-33C shows a cross section of chamfered portion 3303. As can be seen by contrasting views 33C′-33C′ and 33C-33C, chamfered portion 3303 provides a recessed surface in rim 2308 to allow for easier manipulation of a remove tab disposed within extension 3302. While the contour of chamfered portion 3303 as shown in view 33C-33C is curved, other contours are possible. For example, the contour could be a substantially linear incline with an arbitrary slope.

All of the disclosed embodiments are illustrative of the various ways in which the present invention may be practiced. Additionally, any of the disclosed embodiments for the components of the floor mat, e.g., the base portion, the tacky portion, the graphic display, and thus all of the features associated with these components, may be combined in any embodiment of the present invention and the present invention is not limited to only the particular combined embodiments disclosed. Other embodiments can be implemented by those skilled in the art without departing from the spirit and scope of the present invention.

What is claimed is:

1. A base portion underlayer of a floor mat, said base portion underlayer having an area configured to receive a removable tacky insert, wherein said area has a layer thereon for promoting adhesion of said tacky insert to said base portion underlayer.

2. The base portion underlayer of claim 1, wherein said adhesion promoting layer is one of the family of acrylics and urethanes.

3. The base portion underlayer of claim 1, wherein said adhesion promoting layer is one of a pliable and a rigid mechanical member.

4. A base portion underlayer of a floor mat, said base portion underlayer having an area configured to receive a removable tacky insert, and said area having channels therein.

5. The base portion underlayer of claim 4, wherein said channels are interconnected.

6. The base portion underlayer of claim 4, wherein said channels form a grid.

7. The base portion underlayer of claim 4, wherein said area further has a layer thereon for promoting adhesion of said tacky insert to said base portion underlayer.

8. A base portion underlayer of a floor mat, said base portion underlayer having an area configured to receive a removable tacky insert, said area having a rim with an extension for receiving a remove tab of said tacky insert.

9. The base portion underlayer of claim 8, wherein said extension includes a chamfered portion.

10. The base portion underlayer of claim 9, wherein said chamfered portion has a curved contour.

11. The base portion underlayer of claim 9, wherein said chamfered portion has a substantially linear contour.

12. The base portion underlayer of claim 8, wherein said area includes channels.

13. The base portion underlayer of claim 8, wherein said area has a layer thereon for promoting adhesion of said tacky insert to said base portion underlayer.

14. A base portion underlayer of a floor mat, said base portion underlayer having an area configured to receive a removable tacky insert, said area comprising:
interconnected channels; and
a layer thereon for promoting adhesion of said tacky insert to said base portion underlayer;
wherein said area has a rim with an extension for receiving a remove tab of said tacky insert, said extension having a chamfered portion, and wherein a portion of said area adjacent to said extension is channel-free.

15. A floor mat comprising:
a base portion underlayer having a bottom surface for contact with a floor, and a top surface;
wherein said top surface comprises:
a raised border defining an area for receiving a non-tacky layer; and
a rim within said border defining an area for receiving a tacky insert;
and wherein said area for receiving a tacky insert comprises:
anti-slip components;
interconnected channels; and
a layer thereon for promoting adhesion of said tacky insert to said base portion underlayer;
and wherein said rim has an extension for receiving a remove tab of said tacky insert, said extension having a chamfered portion, and wherein a portion of said area for receiving a tacky insert adjacent to said extension is channel-free.
